(19) United States
(12) Patent Application Publication
(10) Pub. No.: US 2004/0202309 A1
(43) Pub. Date: Oct. 14, 2004

(54) Managing the rate of delivering performance interventions in a contact center

(75) Inventors: Rick Baggenstoss, Decatur, GA (US); John C. C. McIlwaine, Alpharetta, GA (US); Jennifer C. East, Alpharetta, GA (US); Scott Richter, Gainesville, GA (US); Robert L. Beard, Alpharetta, GA (US); Lisa Marie Foley, Atlanta, GA (US)

Correspondence Address: Michael L. Wach, KING & SPALDING LLP, 45th Floor, 191 Peachtree Street, N.E., Atlanta, GA, 30303, US

(73) Assignee: Knowlagent, Inc., Alpharetta, GA

(21) Appl. No.: 10/733,457

(22) Filed: Dec. 11, 2003

Related U.S. Application Data
(63) Continuation-in-part of application No. 10/602,804, filed on Jun. 24, 2003.
Application No. 10/602,804 is a continuation of application No. 09/442,207, filed on Nov. 16, 1999, now Pat. No. 6,628,777.

(51) Int. Cl. H04M 3/00; H04M 5/00

(52) U.S. Cl. 379/265.06

(57) ABSTRACT

Managing the rate of delivering performance interventions, such as training sessions, to agents in a contact center, such as a call service center benefits the operations of the contact center. Managing this rate can include adjusting the number of performance interventions delivered in an increment of time according to the state of the contact center. The state of the contact center can be determined by monitoring or predicting contact center performance. Contact center performance increasing above or falling below a management input level can trigger an increase or decrease in intervention delivery rate. In coordination with determining delivery rate, agents can be selected to receive interventions based on ranked performance or need.

### CROSS REFERENCE TO RELATED APPLICATIONS

This application is a continuation in part of U.S. patent application Ser. No. 10/602,804, filed Jun. 24, 2003, which is a continuation of U.S. application Ser. No. 09/442,207, now U.S. Pat. No. 6,628,777, entitled “Method and System for Scheduled Delivery of Training to Call Center Agents,” issued Sep. 30, 2003.

This application is related to U.S. Non-Provisional Patent Application, serial number unassigned, entitled “Managing the Selection of Performance Interventions in a Contact Center,” filed Dec. 11, 2003 and having attorney docket number 07117.105017.

### TECHNICAL FIELD

The present invention relates generally to contact centers, such as call service centers, and more specifically to managing the rate of delivering performance interventions, such as training sessions, for agents in a contact center.

### BACKGROUND OF THE INVENTION

A contact center, such as a call center, is a system that enables a staff of agents to service telephone calls to or from customers or other constituents. Modern contact centers generally incorporate computer-based systems for automatically handling calls and managing various operational aspects of the contact center. Contact center operations benefit from the recent availability of automated systems that deliver performance interventions, such as training content, to agents via a computer terminal.

Agents in contact centers and other constituent service centers must be well-trained in order to maximize their productivity and effectiveness. Agent training must be intensive and frequent in centers that handle complex interactions with constituents or that change call scripts or other interaction programs often. In many situations, the quality and effectiveness of agent training may significantly drive the performance of the contact center.

In conventional contact centers, training is provided to contact center agents through a variety of mechanisms. The supervisor of the contact center may simply walk over to individual agents, place telephone calls to the individual agents, or pass on new information to the agents personally. New information may be distributed by email, by an instructor in a classroom setting, or over an intranet. Alternatively, the information may be broadcast over a public announcement system or may be displayed on a large wall display at the front of the contact center. New information may also be provided through a “chair drop” by which written information updates or training materials are handed to the agents for their consumption.

More recently, automated methods for agent training and information updating have been developed. Computer-based training (“CBT”) involves the distribution of training programs to an agent's computer desktop. CBT content may be distributed in a broadcast mode, with each agent receiving the same training at the same time. CBT may more effectively be deployed by allowing individual agents to access desktop training on their own schedule and at their own pace through self-directed CBT. In self-directed CBT, each agent takes the initiative to enter a training session, and the pace and content of the training can reflect individual agent learning rates and base knowledge.

While computer-based training methods offer significant benefit in training effectiveness, efficiency, and sophistication to contact centers and other constituent contact centers, conventional CBT-based training regimens have significant drawbacks. Broadcast CBT systems generally require that a group of agents be diverted en masse from their customer interaction duties for a period of time, and those systems do not accommodate large variations in learning rate or base knowledge among agents. While self-directed CBT enables agents to learn at their own pace and to enter training sessions when they wish, conventional self-directed training is not generally amenable to centralized management and control by the contact center. Furthermore, self-directed CBT generally does not support a coordinated approach to training or facilitate controlling the number of training sessions conducted in an increment of time. Without such coordination and control of training rate, the contact center's short-term operational effectiveness can be adversely impacted by training. Because of the limitations of convention CBT and other performance interventions, conventional contact centers may forego providing agents with performance interventions in order to meet short-term performance objectives. Conversely, such contact centers may compromise short-term performance in order to meet long-term training objectives.

In addition to failing to balance short- and long-term objectives, conventional contact centers do not generally deliver performance interventions in a manner that adequately responds to changing conditions, such as fluctuating call volume and contact center performance. More specifically, conventional contact centers generally neither set the number of performance interventions delivered in an increment of time nor select performance interventions for delivery on the basis of such dynamic conditions.

Rather than respond dynamically to changing conditions in the contact center, contact centers often rely on conventional schedules to dictate a timeframe for delivering performance interventions. A member of the contact center's management staff usually drafts such schedules manually. Often drafted weeks in advance, the schedules are typically fixed and can not easily accommodate the inherent uncertainty and fluid nature of the contact center's operations. Consequently, such static schedules are limited in terms of capability to adjust the number of interventions delivered in an increment of time in response to the dynamic conditions of a contact center.

Another problem with conventional approaches to scheduling performance interventions in a contact center is related to the management staff's approach to generating agent work schedules. Management typically generates work schedules for the contact center's agent staff weeks in advance. Generally, management devises these schedules with the goal of maximizing the time that each agent spends servicing contacts. Management typically prefers a schedule that keeps the agents too busy rather than a schedule that provides excess idle time. This approach not only serves short-term profit objectives, but also compensates for unanticipated lulls in the contact center's activity levels. Consequently, conventional agent schedules usually provide insufficient time for conducting performance interventions. In other words, from a planning perspective, the contact center typically does not have sufficient available time on the schedule to provide a desirable level of performance interventions.

Although conventional schedules do not usually accommodate an adequate level of performance interventions, the actual operations in a contact center frequently deviate substantially from the planned activities. In an ordinary day, unexpected circumstances and/or randomness cause decreases in call volume which offer an opportunity to deliver one or more performance interventions. However, conventional scheduling methodologies generally do not provide for utilizing such unexpected available time. In other words, a contact center typically has incremental downtime that is underutilized for delivering performance interventions because conventional schedules typically lack provisions for its utilization.

What is needed is a capability for managing the number of performance interventions delivered in a contact center in an increment of time in a manner that is responsive to changing conditions in the contact center. This capability should adjust the rate of performance intervention delivery according to activity levels and performance of the contact center. Such a capability would promote the overall performance and proficiency of the agent population in the contact center without compromising the performance of the contact center during performance intervention delivery.

### SUMMARY OF THE INVENTION

The present invention supports managing performance intervention delivery to agents in a contact center. A performance intervention can be a communication delivered to an agent with the intent to enhance the performance, proficiency, and/or effectiveness of that agent. Computer-based training can be an example of a performance intervention. A contact center can be a system staffed with agents who service customers or constituents though a communication network. An inbound call center can be one example of a contact center.

According to one aspect, the present invention can manage performance intervention delivery by controlling the rate of delivering performance interventions to agents in a contact center. Delivery rate can be the number of performance interventions for which delivery is initiated or completed in an increment of time, such as a day, an hour, or a second. Factors that describe or effect a contact center's operations can be characterized as contact center state. The rate at which the contact center services contacts or receives incoming calls are two examples of contact center state. Contact center state can also be a measurement of the center's performance, such as the average time that a contact waits prior to receiving service from an agent. The present invention can control the rate of delivering performance interventions based on a current or a forecasted state of the contact center.

According to another aspect of the present invention, management input, such as an input level of contact center state, can be a factor in managing performance intervention delivery. A computer program can compute an intervention delivery rate based on the management-input state level and a current or a predicted contact center state. The computer program can adjust the rate of delivering performance interventions to maintain contact center performance at or above a management-input performance level. Contact center performance dipping below the level can trigger a decrease in the performance intervention delivery rate. Similarly, performance rising above the level can trigger an increase in intervention delivery rate.

According to another aspect of the present invention, a computer program can select agents to receive performance interventions in conjunction with determining a rate for delivering performance interventions. Agent selection can be based on need. Lower performing agents can preferentially receive performance interventions over higher performing agents. Ranking the relative performance of each agent in a group of agents can define a sequence for delivering performance interventions to the group.

The discussion of managing performance intervention delivery presented in this summary is for illustrative purposes only. Various aspects of the present invention may be more clearly understood and appreciated from a review of the following detailed description of the disclosed embodiments and by reference to the drawings and claims.

### BRIEF DESCRIPTION OF THE DRAWINGS

FIG. 1 is a block diagram illustrating a system for managing a computer-based customer call center system in accordance with an exemplary embodiment of the present invention.

FIG. 2 is a block diagram illustrating a system for the scheduling and delivery of training materials in accordance with an exemplary embodiment of the present invention.

FIGS. 3A, 3B, and 3C are flow charts indicating the steps in the methods for training a contact agent to perform constituent contact duties in accordance with an exemplary embodiment of the present invention.

FIG. 4 illustrates a functional block diagram of a contact center with an Intervention Manager according to one exemplary embodiment of the present invention.

FIG. 5A illustrates inputs and outputs of an Intervention Manager according to one exemplary embodiment of the present invention.

FIG. 5B illustrates functional relationships between primary inputs and primary outputs of an Intervention Manager according to one exemplary embodiment of the present invention.

FIG. 5C illustrates functional relationships between primary inputs and primary outputs of an Intervention Manager according to one exemplary embodiment of the present invention in which the rate of intervention delivery is based on intervention parameters and contact center state.

FIGS. 6A and 6B graphically illustrate adjusting the number of performance interventions delivered over time based on the state of a contact center according to one exemplary embodiment of the present invention.

FIGS. 7A and 7B graphically illustrate predicting the state of a contact center and managing performance intervention delivery based on the prediction according to one exemplary embodiment of the present invention.

FIG. 8 graphically illustrates adjusting the rate of delivering performance interventions based on the state of the contact center according to one exemplary embodiment of the present invention.

FIG. 9 graphically illustrates selecting performance interventions based on performance intervention priority and contact center state according to one exemplary embodiment of the present invention.

FIG. 10 illustrates a flow chart for an algorithm for managing performance intervention delivery according to one exemplary embodiment of the present invention.

FIG. 11 illustrates a flow chart for an algorithm for adjusting the rate of delivering performance interventions according to one exemplary embodiment of the present invention.

FIG. 12 illustrates a flow chart for an algorithm for selecting performance interventions according to one exemplary embodiment of the present invention.

FIG. 13 illustrates a flow chart for an algorithm for selecting agents to receive performance interventions according to one exemplary embodiment of the present invention.

FIG. 14 illustrates a flow chart for an algorithm for delivering performance interventions to agents according to one exemplary embodiment of the present invention.

FIG. 15 illustrates a flow chart for an algorithm for controlling the delivery of performance interventions to agents according to one exemplary embodiment of the present invention.

### DETAILED DESCRIPTION OF EXEMPLARY EMBODIMENTS

The present invention is directed to managing the delivery of performance interventions, such as training sessions, to agents in a contact center to enhance the operational effectiveness of the contact center. Delivering performance interventions increases the effectiveness, performance, and proficiency of the agent population. Managing the delivery of performance interventions to agents includes controlling the intervention delivery process to avoid adversely impacting the performance of the contact center during intervention delivery.

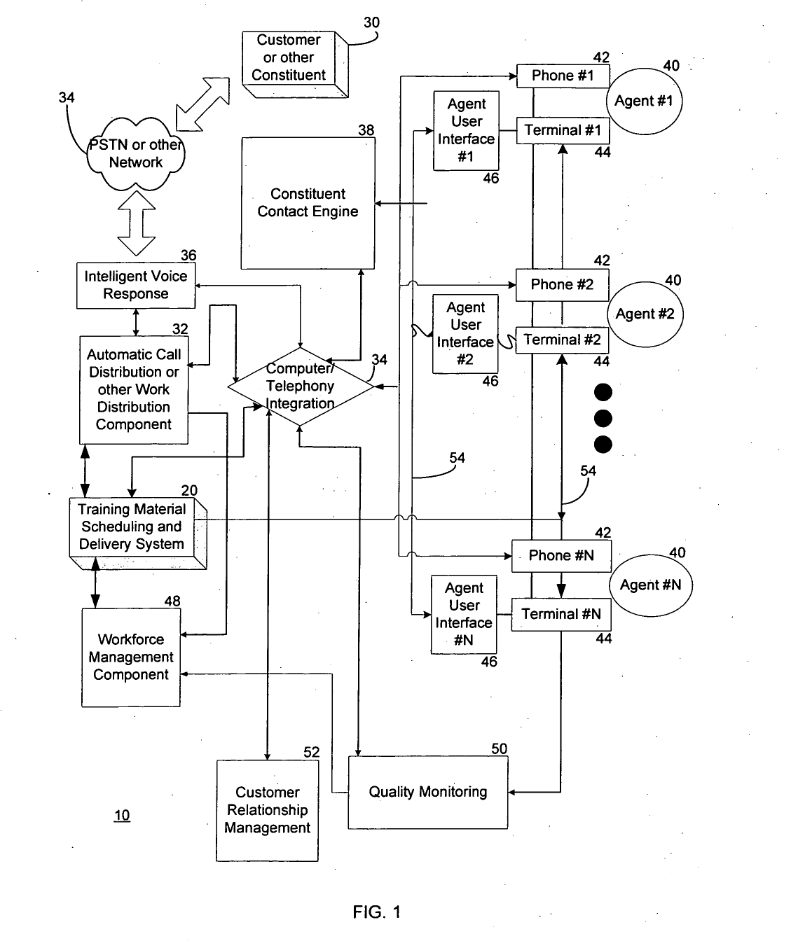

Description, FIGS. 1-3

Turning now to the drawings, in which like numerals indicate like elements throughout the several figures, an exemplary embodiment of the invention will now be described. FIGS. 1-3 are directed to the scheduled delivery of content, such as training, to a constituent contact agent, such as a call center agent. Although FIGS. 1-3 will be described with respect to the delivery of training materials to an agent in a call center, those skilled in the art will recognize that the invention may be utilized in connection with the scheduled delivery of a variety of information in other operating environments.

FIG. 1 illustrates a computer system for managing a call center in which one advantageous embodiment of the present invention is implemented. The illustrated call center 10 includes a training system 20 operative to schedule and deliver training materials to call center agents 40. In a typical application of the call center 10, a customer 30 calls via the public switched telephone network (“PSTN”) or other network to the call center 10. The customer call may be initiated in order to sign up for long distance service, inquire about a credit card bill, or purchase a catalog item, for example. Through the PSTN 34, the call from the customer 30 reaches an Automatic Call Distribution (“ACD”) component 32 of the call center. The ACD component functions to distribute calls from customers to each of a number of call center agents 40 who have been assigned to answer customer calls, take orders from customers, or perform other duties. Agents are typically equipped with a phone 42 and a call center computer terminal 44 for accessing product information, customer information, or other information through a database. For example, in a call center implemented to support a clothing catalog, the terminal 44 for an agent could display information regarding a specific item of clothing when a customer 30 expresses an interest in purchasing that item.

Customer phone calls and relevant database information are integrally managed by modern call centers 10 through what is known as computer/telephone integration (“CTI”). A CTI component 34 enables the call center 10 to extract information from the phone call itself and to integrate that information with database information. For example, the calling phone number of a customer 30 may be used in order to extract information regarding that customer stored in the call center database and to deliver that customer information to an agent 40 for the agent's use in interacting with the customer. CTI 34 may also interact with Intelligent Voice Response (“IVR”) unit 36, for example to provide a touchtone menu of options to a caller for directing the call to an appropriate agent.

Depending on the nature and function of the call center, a constituent contact engine 38 is a software-based engine within the call center 10 that manages the interaction between customers and agents. For example, the constituent contact engine 38 may sequence the agent 40 through a series of information screens in response to the agent's information input during a customer call. The agent advantageously provides input to the constituent contact engine 38 through an agent user interface 46, which is typically a graphical user interface presented at a computer terminal 44.

A typical call center 10 includes a Workforce Management (“WFM”) component 48. WFM component 48 is used to manage the staffing of agents 40 in the call center 10 so that call center productivity can be optimized. For example, the volume of calls into or out of a call center 10 may vary significantly during the day, during the week, or during the month. WFM component 48 preferably receives historical call volume data from ACD component 32. The WFM component 48 can determine an appropriate level of staffing of agents 40 so that call hold times are minimized, on the one hand, and so that agent overstaffing is avoided, on the other hand.

In a typical call center, customer calls and interactions between customers and agents 40 are selectively sampled as part of a quality control program within the call center 10. This function is typically performed through a Quality Monitoring component 50 that monitors voice interaction through the agent's phone 42 and monitors information delivered through the system to the agent's terminal 44. In addition, Customer Relationship Management (“CRM”) systems 52 are often employed in call centers for a variety of marketing or customer service functions. For example, a CRM system 52 may be used to suggest to a caller ordering a certain book that the caller may wish to purchase other related books or other books that have been ordered by purchasers of the same book.

The call center 10 includes a communications network 54 to interconnect and link the aforementioned components. For a call center in which all elements are located at the same site, for instance, a local area network may provide the backbone for the call center communications network 54. In call centers for which the elements are geographically dispersed, the communications network may comprise a wide area network, a virtual private network, a satellite communications network, or other communications network elements as are known in the art.

The training system 20 according to one advantageous embodiment of the present invention is implemented in software and is installed in or associated with the call center computer system 10. By integration with the WFM component 48 and/or the CTI 34 of the call center, the training system 20 can deliver training material to agents 40 via communications network 54 in scheduled batches. Integration with the WFM component 48 and the CTI 34 enables the training system 20 to deliver training materials to agents at times when those agents are available and when training will not adversely impact call center performance. The training system 20 is also preferably in communication with quality monitoring component 50 through the communications network 54 so that training materials may be delivered to those agents who are most in need of training. Proficient agents are thus spared the distraction of unneeded training, and training can be concentrated on those agents most in need. Advantageously, call center management may set pass/fail criteria within the quality monitoring component 50 to trigger the scheduling of appropriate training to appropriate agents. This functionality may be provided via a rules engine implemented as part of the training system 20 or within the contact engine of the call center. By integrating with the CTI 34, the training system 20 can deliver training materials based on CTI-derived data such as customer call volume, independent of or complemented by the training schedule derived from the workforce management component 48 or the work distribution component 32.

In another advantageous embodiment of the present invention, the training system 20 may be deployed on a stand-alone server located remotely from call center 10. For example, training system could be deployed to serve a number of independent call centers 10, such as in a “web services” business model. In such a remote deployment, the problems of integration with individual call center computer systems can be avoided and the training system 20 can be maintained at a single central location.

A wide range of agent training scenarios can be supported by the training system 20. The training materials that are appropriate for a particular call center application can vary according to the call center function. The subject matter of training materials may also vary widely; for example, training materials may be focused on product information, phone etiquette, problem resolution, or other subjects.

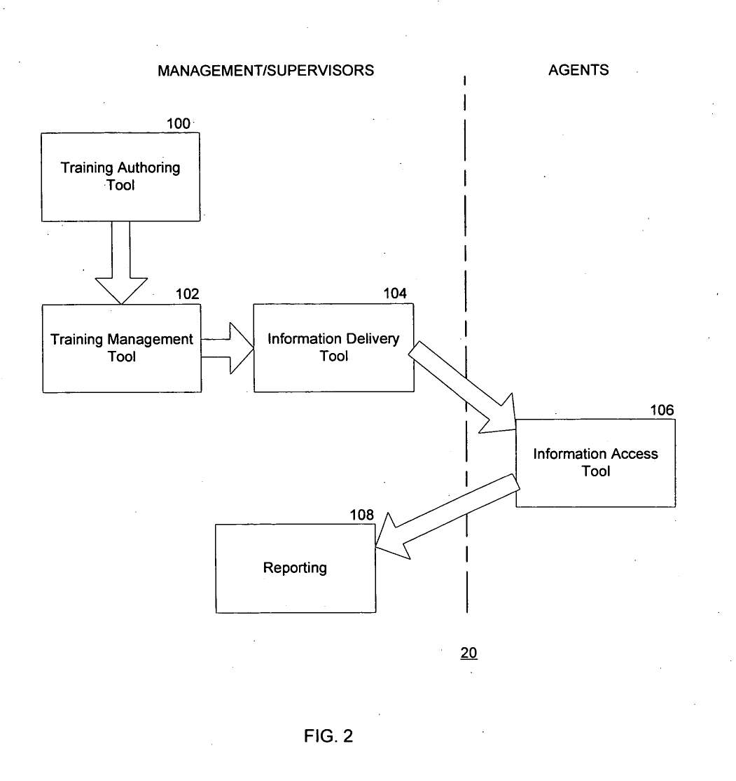

FIG. 2 is a block diagram illustrating a training system 20 for the scheduling and delivery of training materials to call center agents 40 in a call center 10. The training system includes a number of interoperable software modules. Training authoring tool 100 is a software module that enables the managers of a call center to develop training materials, training courses, training quizzes, and other information to be delivered to agent 40 in the call center. Training system 20 preferably further includes a training management tool 102 that enables call center managers to assign agents to groups for training purposes, to assign training materials to individual groups, and to assign groups of courses to supersets of training groups.

The training system 20 preferably further includes an information delivery tool 104 that determines when the training materials assigned by the training management tool 102 are to be delivered to agents. The information delivery tool 104 preferably receives agent workload data and call center load data from ACD 32 through CTI 34. The information delivery tool 104 also preferably receives agent schedule data from WFM 48. The training system further comprises information access tool 106 for delivering the training materials to agents over communications network 54 on a scheduled basis so as not to disrupt agent customer contact duties. Agent consumption of training and training quiz performance are tracked by the reporting module 108, which is preferably adapted to generate standard and custom reports to enable call center managers and supervisors to more effectively manage agent performance and training.

Turning now to FIGS. 1, 2, and 3A, the steps in a method for delivering scheduled training to a contact agent within a call center operating environment are illustrated in flow chart form. The method begins at step 200. At step 202, the information delivery tool 104 within training system 20 accepts agent schedule data from WFM component 48 of the call center computer system 10. The agent schedule data may be in many forms, but in one example the data includes agent assignments to the call center sorted by quarter-hour over a period of several days. At step 204, the training system 20 analyzes the agent schedule data provided by the WFM component 48 to determine whether the agent is schedule for training. The method then proceeds to step 206; if the agent is not scheduled for training, the “No” branch of the flow chart is followed and the method returns. If the agent is scheduled for training, then the “Yes” branch is followed to step 208, where the agent's interaction with the agent user interface is monitored by information delivery tool 104 of the training system 20. For example, mouse movements or keyboard activity at the agent user interface can be monitored to determine whether the agent is handling a customer call. The method then proceeds to step 210, where the training system 20 determines, from the user interface activity, whether or not the agent is available for training. If the agent is not available for training, the method proceeds through the “No” branch to a wait loop at step 211 and the agent's interaction with the agent user interface is again monitored at step 208. If the agent is available for training, the method proceeds through the “Yes” branch to step 212, at which step the agent is prompted by the training system that training is available. This prompt may, for example, take the form of a pop-up screen delivered to the agent's terminal displaying a message indicating that training is now available for the agent.

The method then proceeds to step 214 at which step the training system 20 looks for an acknowledgment from the agent that the agent is ready for training. If the agent has not acknowledged by a certain predetermined time, for example, then the method proceeds through the “No” branch and returns. If the agent does acknowledge that the agent is ready for training, the method proceeds through the “Yes” branch to step 218, at which step training materials are delivered to the agent by information access tool 106 within the training system 20 over the communications network 54. Preferably, the agent has logged off of the call center computer system contact engine 38 before the training materials are delivered. In this exemplary method, the training materials delivered can, for example, comprise a sequenced series of training segments each of limited duration that together form an integrated whole. Of course, the training materials can vary considerably from call center to call center as dictated by the function of the call center and the business supported by the call center 10. The training materials delivery step 218 may be set to terminate after a predetermined amount of time. The method then terminates at step 220.

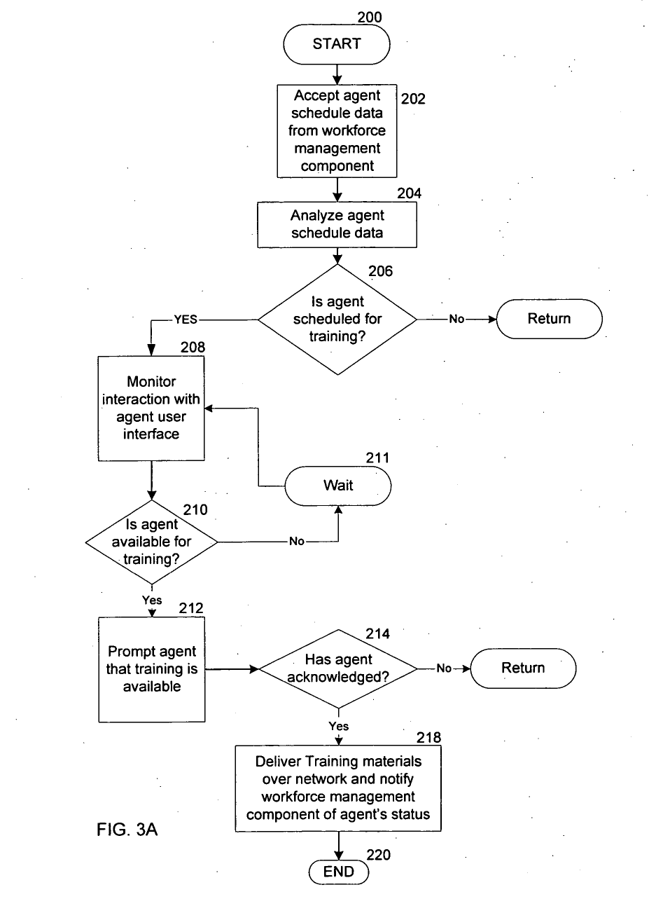

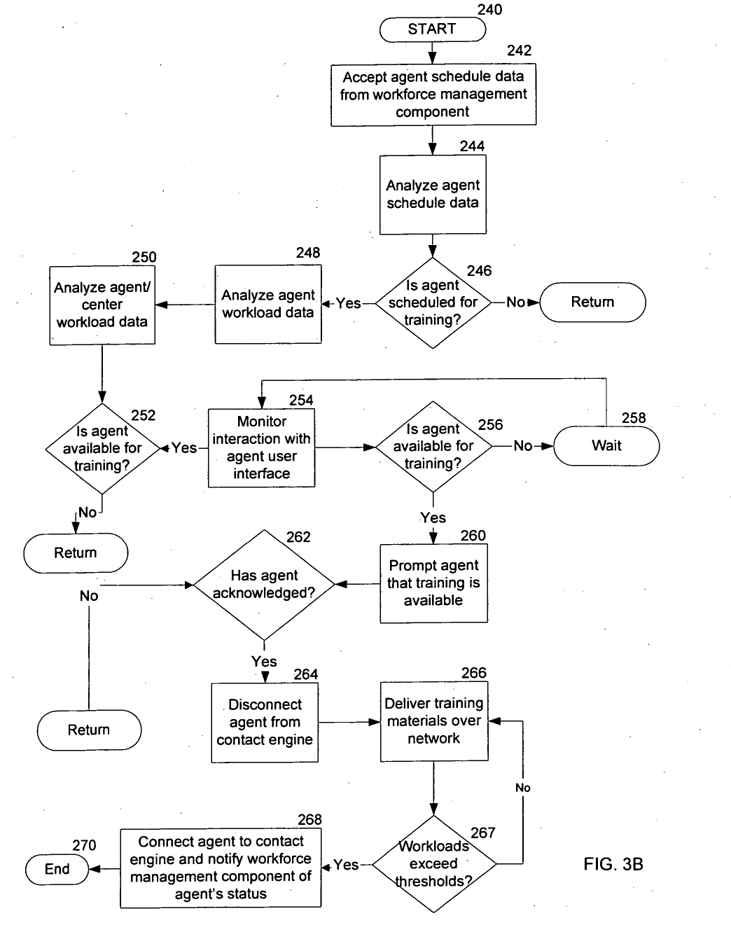

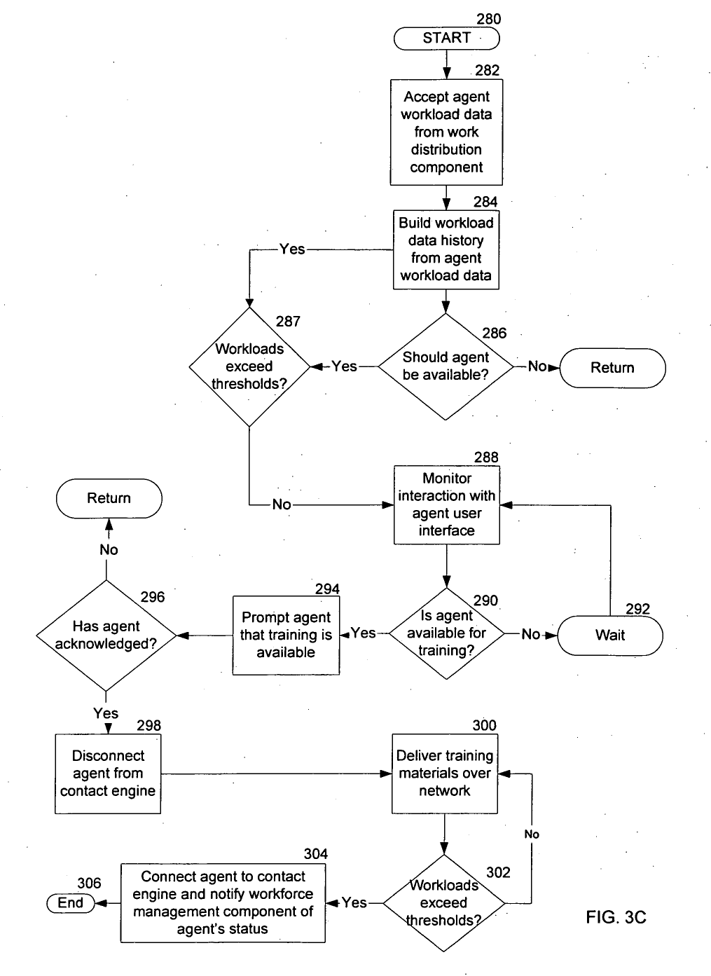

Accordingly, the method according to one exemplary embodiment as illustrated in the flow diagram of FIG. 3A accepts and analyzes agent schedule data provided from the WFM component of a call center computer system in order to non-disruptively schedule and deliver agent training.

According to another advantageous embodiment, the steps in a method for managing a call center or other constituent contact system are illustrated in the flow diagram of FIG. 3B. According to this exemplary method, information from both the workforce management component 48 and the automatic call distribution component 32 are used by information delivery tool 104 within the training system 20 to non-disruptively schedule and deliver agent training. Referring now to FIGS. 1, 2, and 3B, the method begins at step 240. At step 242, the information delivery tool 104 accepts agent schedule data from a workforce management component 48 of the call center computer system 10. The method then proceeds to step 244, where the agent schedule data is analyzed by the training system, and then proceeds to step 246. If the training system 20 determines at step 246 that the agent is not scheduled for training, based on the analysis of the agent's schedule data, then the method proceeds through the “No” branch and returns. If the training system 20 determines at step 246 that the agent is scheduled for training, then the method proceeds through the “Yes” branch to step 248.

The information delivery tool 104 of the training system 20 accepts agent workload data at step 248 from the automatic call distribution component 32 or other work distribution component of the call center system. Moving to step 250, the training system 20 analyzes the agent workload data to determine whether the call center's workload metrics (such as call volume or hold time) exceed certain predetermined thresholds. If the call center or the individual agent are too busy for the agent to be available for training, the method proceeds through the “No” branch at step 252 and returns. If the analysis of the call center metrics indicates that the agent is available for training, the method proceeds through the “Yes” branch to step 254.

At step 254, the training system 20 monitors the agent's interaction with the agent user interface, such as by monitoring mouse movements or terminal keystrokes. The training system 20 thereby determines whether or not the agent is available for training at step 256. If unavailable, the method proceeds through the “No” branch to wait loop at step 258, and the agent's interaction with the agent user interface is again monitored at step 254. If the agent is available for training, the method proceeds through the “Yes” branch to step 260.

At step 260, the agent 40 is prompted by the training system 20 that training is available. The prompt to the agent may, for example, be in the form of a pop-up screen delivered to the agent's terminal 44 informing the agent that training is available. According to the method, the training system then waits for an acknowledgment by the agent that the agent is ready for training, as shown at step 262. If the agent does not acknowledge that it is available for training, the method proceeds through the “No” branch and returns. If and when the agent acknowledges the prompt, the method proceeds through the “Yes” branch to step 264 and the agent is disconnected from the contact engine 38 within the call center computer system 10 so that interference between the training session and customer calls can be avoided. At step 266, the information access tool 106 of training system 20 delivers training materials to the agent 40 over the communications network 54.

The information delivery tool 104 monitors the work distribution component 32 at step 267 and determines whether predetermined agent or call center workload thresholds are exceeded during training material delivery. If agent or call center thresholds are not exceeded, then training material delivery continues at step 266. If thresholds are exceeded at step 267, the agent is reconnected to call center contact engine 38 at step 268 to resume customer contact duties, and the method then terminates at step 270.

The agent workload data provided by the ACD 32 or other work distribution component in the method illustrated in FIG. 3B may take many forms. For example, the agent workload data may simply indicate that the level of call center activity within the system exceeds a certain predetermined threshold, and that no training for any agent is therefore appropriate at that time. As another example, the agent workload data may include individual workload data for each of several agents, indicating which, if any, agents are available for a training session. In any event, the agent workload data is preferably real-time or near real-time data reflecting the activity within the call center.

Workload thresholds for all agents as a group or for individual agents may be set advantageously by the manager of the call center depending on the needs of the particular call center. For example, if reports from the quality monitoring component 50 indicate that the quality of call center interactions with customers has declined over the past week, the thresholds may be adjusted so that training is provided even when the call center is relatively busy. Advantageously, these thresholds may also be set automatically as a function of data supplied by the quality monitoring component 50.

FIG. 3C illustrates the steps in a method according to another advantageous embodiment of the present invention. As shown in FIG. 3C, a method is provided for managing a constituent contact system for a call center based on workload data from a work distribution component, such as an ACD.

Referring now to FIGS. 1, 2, 3C, the method starts at step 280. At step 282, the information delivery tool 104 of the training system accepts agent workload data from the ACD 32 or other work distribution component. At step 284, the training system 20 builds a workload data history from the agent workload data supplied by the ACD 32. The workload data history may comprise, for example, data indicating the activity for all agents as a whole or for individual agents as a function of recent time. This data is advantageously used by the training system to forecast when and if all agents or some agents should be available for training at some point in the future. For example, if the workload data history indicates that call volume drops significantly between 10 p.m. and midnight on Fridays, then the training system can, by leveraging data from other systems, forecast that call volume will drop next Friday evening. The training system 20 can thereby determine if an agent should be available for training at some point in the future, such as next Friday evening, based on the workload data history.

If the training system 20 determines at step 286 that the agent should be available at an upcoming time, the method proceeds through the “Yes” branch to step 287. If the system forecasts at step 286 that the agent will not be available at the upcoming time, the method proceeds through the “No” branch and returns. At step 287, the training system monitors predetermined agent and call center workload thresholds. If those thresholds are not exceeded, the system proceeds to step 288. If those workload thresholds are exceeded, the system returns to step 284 and updates the workload data history.

At step 288, the training system 20 monitors the interaction of the agent 40 with the agent's user interface 46, such as mouse movements or keystrokes. If the training system 20 determines at step 290 that the agent is not interacting with the agent's user interface 46, then the method proceeds through the “Yes” branch to step 294. If the agent is interacting with the agent's user interface, then the method proceeds through the “No” branch from step 290 to the wait loop at step 292 and again monitors agent user interface activity at step 288. At step 294, the system prompts the agent that training is available. If the agent does not acknowledge the prompt at step 296, the method returns. If the agent acknowledges the prompt at step 296, the system disconnects the agent from the call center contact engine at step 298 and proceeds to step 300.

At step 300, training materials are delivered by the information access tool 106 to the agent 40 over the communications network 54. Workload metrics for the agents in the call center and for the call center as a whole are monitored according to step 302; if the workloads exceed predetermined thresholds, then the method proceeds through the “No” branch back to step 300 and the delivery of training materials continues. If, on the other hand, the workload levels through the training system increase beyond a predetermined threshold or a predetermined length for the training session is exceeded during the delivery of training materials to the agent, then the method proceeds through the “Yes” branch to step 304, and the agent is reconnected to the call center contact engine so that the agent can return to handling customer call. The method ends at step 306.

It should be emphasized that the illustration of a call center environment in the preceding discussion is an example of one common application that can take advantage of the present invention, but that the present invention is not limited to call centers or to the delivery of training materials. The methods provided by the present invention can be applied in any constituent contact environment and may include a variety of media through which contact with constituents may be made by the constituent contact system. For example, constituents may include, in addition to customers, the employees of an organization, sale representatives of an organization, suppliers of an organization, contractors of an organization, or other constituents.

Moreover, according to the present invention, the medium of communication between the system and the constituents may include voice contact over the public switched telephone network, e-mail communications provided through the Internet, Internet-based “chat” contact, video communications provided over the Internet or over private broadband networks, or other communications media and forms as are known in the art.

In addition, the method provided by the present invention includes the delivery of a broad range of information to constituent contact agents. In addition to the training materials described above by way of example, any sort of information amenable to distribution via a digital communications network may be delivered in accordance with present invention. For example, new information, real-time video, sporting event information, music, conference call voice and video information, or other text, audio, video, graphics, or other information may be delivered without departing from the invention.

According to another aspect of the invention, a computer readable medium having computer executable instructions is provided that includes software components adapted to perform steps corresponding to the steps in the methods described above. According to one advantageous embodiment, a scheduling component, a monitoring component and a delivery component are provided. The scheduling component accepts agent schedule data from the training system or the other constituent contact system, including data regarding the assignment of an agent within the organization to perform communications duties via the system. The scheduling component also analyzes the agent schedule data to determine when the agent is scheduled to receive information and to schedule an information delivery session for the agent. The monitoring component monitors the agent's communications with constituents, such as through monitoring a user interface, in order to determine whether or not the agent is available to receive the information. The delivery component is adapted to deliver information to the agent over the communications network at times when the agent is scheduled to receive information as well as available to receive information.

In summary, the present invention can schedule and deliver training or other information to agents in a call center or other constituent contact system. Training materials or other information may be scheduled and delivered to an agent without disrupting the agent's customer contact duties. Agent schedule data from a workforce management component or agent workload data from a work distribution component may be analyzed to decide whether or not an agent is scheduled for training or available for training. The user interface on the agent's terminal may be monitored by the training system 20 to determine whether the agent is busy interacting with constituents. If the agent is not busy, training materials or other information may be delivered to the agent's desktop through the system's communications network. To avoid interference between a training session and the agent's customer call duties, the agent may be disconnected from the system's customer contact engine before delivery of the training materials. If the call center's call volume or other metric exceeds a predetermined threshold during the training session, the session may be discontinued so that the agent may return to the agent's customer call duties.

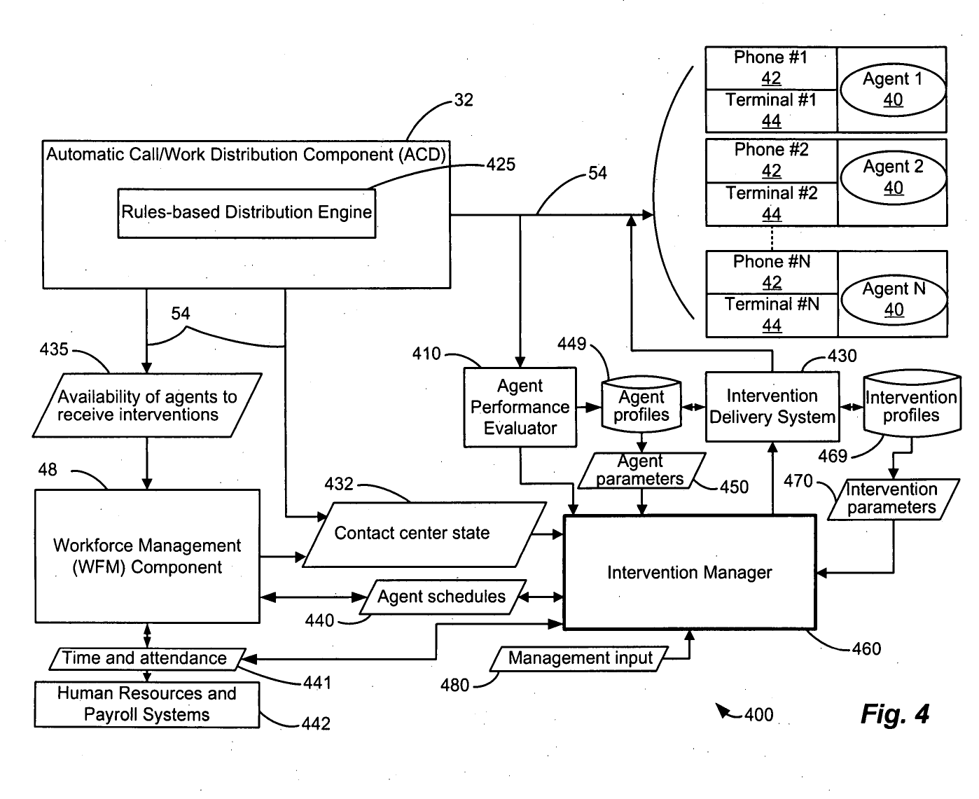

Description, FIGS. 4-15

In addition to those embodiments discussed in connection with FIGS. 1-3, further embodiments of the present invention will be described in reference to FIGS. 4-15.

A performance intervention is a communication delivered, preferably via computer, to an agent with the intent to enhance the performance, proficiency, and/or effectiveness of that agent. A computer system can deliver the communication automatically or in response to manual input. The communication may be delivered exclusively via computer; alternatively, a computer and a human can collaborate to deliver the communication. For example, the computer can print out a recommended coaching script, and a human can follow the script in delivering coaching via traditional verbal communication. CBT sessions are one example of performance interventions. Reprimands, rewards, advice, coaching, one-on-one coaching, peer-to-peer coaching, supervisor-to-peer coaching, notices, warnings, feedback, reports, compliance statistics, performance statistics, and acknowledgements are other examples of performance interventions.

The term “state” or “contact center state” is used herein to refer to factors that describe or effect the contact center's overall operations. Contact center state includes measurements related to workload or activity level such as current call volume, historical call volume, and forecast call volume, each of which is sometimes described seasonally or over another increment of time. Contact center state also includes performance of the contact center. Time metrics of a contact center's performance include average handling time, hold time, average waiting time for each incoming call, and the fraction of calls connected to an agent within a specific length of time following call receipt. Additional metrics of contact center performance include agent performance indicators aggregated to the entire center and/or the center's agent population. Customer satisfaction index, abandonment, service level, compliance statistics, revenue goals and actuals, service level, new product roll out schedules, management directives, natural disasters, and catastrophic events are further examples of contact center state.

The term “abandonment rate” refers to the fraction of contacts who are engaged with the contact center but disconnect communication with the contact center prior to receiving service from an agent. The term “call volume” or “contact volume” refers to the number of calls or contacts that are engaged with the contact center in a unit of time, such as per day, per hour, per minute, or per second. The term “hold time” refers to the length of time between the contact center engaging a contact and an agent of the contact center initiating service with the contact. For example, hold time in an inbound call center is the time that the caller must wait on hold prior to being connected to an agent. The term “service level” refers to the percentage of incoming inquiries that are addressed in a target period of time, such as 80% of incoming calls answered within ten seconds.

The term “state level” or “state level setting” is used herein to refer to a specified contact center state. For example, management can define a state level specifying that at least 80% of calls should be answered within twenty seconds and that a lower percentage of calls answered is unacceptable. A state level can also be a target or otherwise desired operational state. A “performance level” or a “performance level setting” is a state level setting for a performance-based state. “State range” is a range of states. Two examples of state ranges are the states that are above a specified state level and that states that are between an upper state level and a lower state level.

The term “contact center” is used herein to include centers, such as service centers, sales centers, and call centers that service inbound calls and/or outbound calls. A contact center can serve customers or constituents that are either internal or external to an organization, and the service can include audible communication, chat, and/or e-mail. A contact center can be physically located at one geographic site, such as a common building or complex. Alternatively, a contact center can be geographically dispersed and include multiple sites with agents working from home or in other telecommuting arrangements.

A typical computer-based contact center is an information rich environment. A network of data links facilitates information flow between the center's component systems. By tapping this network, the present invention can access historical, current, and forecast information from various center components and utilize this information in the process for managing performance intervention delivery. Consequently, the present invention can be responsive to new situations in the contact center environment, to fluctuations in contact center activity, and to other changes in the center's state.

Although an embodiment of the invention will be described with respect to managing the delivery of performance interventions at a contact center, those skilled in the art will recognize that the invention may be utilized in connection with the deployment of a variety of resources in other operating environments. One example other than a traditional call center environment is a technical support center within an organization that serves employees or members. Those skilled in the art will further recognize that the present invention may be utilized in connection with servicing inbound and outbound contacts at a contact center.

More generally, the business function provided by a contact center may be extended to other communications media and to contact with constituents of an organization other than customers. For example, an e-mail help desk may be employed by an organization to provide technical support to its employees. Web-based “chat”-type systems may be employed to provide information to sales prospects. When a broadband communications infrastructure is more widely deployed, systems for the delivery of broadband information, such as video information, to a broad range of constituents through constituent contact centers will likely be employed by many organizations.

Turning now to discuss each of the drawings presented in FIGS. 4-15, in which like numerals indicate like elements throughout the several figures, an exemplary embodiment of the invention will be described in detail.

FIG. 4 illustrates a system for managing a contact center in which one advantageous embodiment of the present invention is implemented. A contact center 400 includes an arrangement of computer-based components coupled to one another through a set of data links 54 such as a network 54. While some contact center functions are implemented in a single center component, other functions are dispersed among components. The information structure of the contact center 400 offers a distributed computing environment. In this environment, the code that supports software-based process steps does not necessarily execute in a singular component; rather, the code can execute in multiple components of the contact center 400.

The communication network 54 of the contact center 400 facilitates information flow between the center's components. For a contact center 400 in which all elements are located at the same site, a local area network (“LAN”) may provide the backbone for the contact center communication network 54. In contact centers 400 with geographically dispersed components, the communications network 54 may comprise a wide area network (“WAN”), a virtual network, a satellite communications network, or other communications network elements as are known in the art.

In a typical application of the contact center 400, a customer or other constituent calls the contact center 400 via the public switched telephone network (not illustrated in FIG. 4) or other communication network. The customer may initiate the call in order to sign up for long distance service, inquire about a credit card bill, or purchase a catalog item, for example.

An automatic call/work distribution (“ACD”) component 32 receives incoming calls from the telephone network, holds calls in queues, and distributes these calls within the contact center 400. ACD software generally executes in a switching system, such as a private branch exchange. The private branch exchange connects customer calls to terminals 44 operated by contact center agents 40 who have been assigned to serve one or more specific queues, for example to answer customer complaints, take orders from customers, or perform other interaction duties. In alternative embodiments of the invention, the function of the ACD 32 can be replaced by other communications routers. For example, in a contact system 400 using email, an email server and router can distribute electronic messages.

The ACD 32 maintains one or more queues for holding each incoming call that is waiting to be routed to an agent 40, who will service the call. Upon receipt of an incoming call from a customer or other constituent, the ACD 32 categorizes the call and identifies, on the basis of the categorization, a specific queue to hold the call. The ACD 32 then places the call in the specific queue and selects one agent 40 to service the call from a group of agents assigned to service the specific queue. By activating a physical switch, the ACD 32 then routes the call to the select agent 40.

The ACD 32 uses a rules-based distribution engine 425 to categorize each incoming call by applying categorization rules to information that is known about the call. Based on the categorization, the ACD 32 matches the call with one of several queues. In other words, each queue holds a specific category of call. For example, one queue might hold calls from Spanish-speaking callers seeking to order flowers while another queue might hold calls from English-speaking callers seeking to order candy. The rules based distribution engine 425 includes software algorithms that select a specific agent 40 to receive the incoming call. The software algorithms match the call to an agent 40 who is available and has appropriate qualifications and performance history.

When the ACD 32 routes the call to an available agent 40, the agent 40 receives the call and communicates with the caller over a telephone 42 while entering and receiving information through a computer terminal 44. The terminal 44 provides the agent 40 with access to product information, customer information, or other information through databases. For example, in a contact center 400 implemented to support a catalog-based clothing merchant, the computer terminal 44 for an agent 40 could display information regarding a specific item of clothing when a customer expresses an interest in purchasing that item. Agents 40 can also view information about the call that the ACD 32 derived from the call when the call first came into the contact center 400. A desktop application, which is usually a customer resource management component (not shown in FIG. 4), facilitates an agent's interaction with a caller.

In addition to routing calls, the ACD 32 monitors and records call volume and call processing statistics, which are forms of contact center state 432. Thus, the ACD 32 is one type of monitor in the contact center 400 that provides contact center state 432. The ACD 32 provides current and historical measurements 432 of the number of calls that the contact center 400 receives for an increment of time, such as the number of calls received per second, per day, or per shift. The ACD 32 records the length of time 432 that each call waits in a queue before being serviced by an agent 40 and the length of each call. Upon query, the ACD 32 provides aggregate wait time statistics 432 for a specified period of time. The ACD also tracks after-call work, such as notes that an agent enters into the system after concluding service with a contact.

To support routing calls to agents 40 who are available to receive calls, the ACD 32 maintains an activity code for each agent 40. Each agent's activity code describes that agent's current activity. For example, an activity code may report that an agent 40 is servicing a call, idle and waiting to be connected to an incoming call, receiving a performance intervention, taking a break, or in after-call work.

In addition to describing the availability to receive an incoming call, the ACD's activity codes support determining each agent's availability to undertake specific activities. Thus, the ACD 32 maintains data 435 that describes each agent's availability to receive performance interventions. This data 435 is available via the contact center's network 54 to various systems in the center 400, including a workforce management (“WFM”) component 48.

The WFM component 48 manages the staffing level of agents 40 in the contact center 400 to support improving the contact center's productivity and profit. For example, the volume of calls into or out of a contact center 400 may vary significantly during the day, during the week, or during the month. The WFM component 48 can receive historical call volume data from the ACD 32 and use this information to create work schedules 440 for agents 40. WFM components 48 commonly employ the Erlanger Algorithm, which is known to those skilled in the art, to forecast scheduling resources. Historical call volume data 432 can be the basis for forecasting future call volume 432 and/or other forecasts of the contact center's state 432. The WFM component 48 can generate current and forecasted state 432 based on data from the ACD 32 and from its internal information regarding agent staffing.

In one embodiment of the present invention, the WFM component 48 receives current and historical call volume data 432 from the ACD 32. The WFM component 48 fits current and recent call volume data 432 to historical data patterns and projects this data 432 into the future to derive a forecasted call volume 432. In one embodiment of the present invention, this projection is based on a simple linear curve fit. The WFM component 48 overlays forecasted call volume 432 onto an agent work schedule 440 to provide a forecast of contact center performance 432.

The WFM component 48 also communicates time and attendance data 441 to the contact center's human resources and payroll system 442. This communication facilitates computing an agent's compensation based on that agent's activities. Agents 40 may receive bonuses upon complying with a goal, such as servicing calls for more than a specified percentage of the time in a shift. To avoid penalizing an agent 40 for time spent receiving a performance intervention, the WFM component 48 sends a record 441 of such time to the center's human resources and payroll systems 442. The human resources and payroll systems use this information 441 to compute the agent's compensation. In other words, the WFM component 48 communicates information 441 to the human resources and payroll system 442 to facilitate rewarding an agent 40 for productive activities and to avoid penalizing an agent 40 for mandated activities.

Also, an agent 40 in a contact center 400 may receive a bonus or variable pay based on how well the agent 40 adheres to a schedule. To avoid considering an agent 40 out of compliance during the delivery of a performance intervention, the WFM component 48 is notified of the intervention delivery.

As yet another example of coordinating and tracking activities in the contact center 400, the intervention delivery system 430 periodically synchronizes with the WFM component 48 and the ACD 32. The synchronization process includes synchronizing for time spent in training and compliance with training schedules. In one embodiment of the present invention, the Intervention Manager 460 executes this synchronization process.

An agent performance evaluator 410 provides measurements and indications of agent performance that are useful to management and to the various components of the contact center 400. The agent performance evaluator 410 stores these measurements and indications in the agent profiles database 449 and regularly updates them. That is, an agent profile, which is stored in the agent profiles database 449 can include one or more indications of an agent's performance. Various components of the contact center 400 can access this data though the contact center's network infrastructure 54.

In addition to agent performance data, an agent profile can include other agent parameters that describe an agent's capability to contribute to the contact center 40. For example, it can include a characterization of an agent's skills and competencies. Also, it can include an agent's traits, such as personality and cognitive traits.

The agent performance evaluator 410 typically determines the level of agent skill and competency in each of several areas by accessing information from the center components that collect and track agent performance information. Examples of these components include, but are not limited to, the intervention delivery system 430, the WFM component 48, the ACD 32, and a quality monitoring system (not illustrated in FIG. 4). The relevant skills and competencies for a contact center 400 serving a catalog clothing merchant could include product configuration knowledge (e.g. color options), knowledge of shipping and payment options, knowledge of competitor differentiation, finesse of handling irate customers, and multilingual fluency.

In one embodiment of the present invention, the agent performance evaluator 410 includes an agent performance ranking function that assigns a performance rank, or index, to each agent 40. The agent performance evaluator 410 stores each agent's rank in the agent profiles database 449 and provides a list of agents 40 ordered by performance rank to the Intervention Manager 460.

The agent performance evaluator 410 also stores raw monitoring data describing agent performance in the agent profiles database 449. This database 449 is typically maintained in a bulk storage drive or the hard drive of a LAN server, where the data is readily accessible to the Intervention Manager 460 as well as other devices in the contact center 400. Agent performance data includes raw performance statistics as well as aggregated statistics and derived metrics. The agent performance evaluator 410 also generates agent performance data based on performance-related information from various components in the contact center 400. For example, the agent performance evaluator can compute metrics of agent performance, which are characterizations of an agent's job performance, utilizing handling time statistics that are tracked by the ACD 32. Such statistics can be tracked by one or more of the other systems in the contact center 400, such as a customer resource management component (illustrated in FIG. 1 but not in FIG. 4). In one embodiment of the present invention, the agent performance evaluator 410 determines performance indicators such as: close ratio, first call resolution, quality, complaint ratio, cross-sales rate, revenue per call, and average handling time for each agent 40.

In one embodiment of the present invention, the agent performance evaluator 410 is a system that is physically dispersed in the contact center 400. In this configuration, the agent performance evaluator 410 can include the system components in the contact center that contain agent performance information such as average handling time, close ratio, quality, etc. The intervention delivery system 430 uses performance monitoring data to ascertain performance gaps that exist for one or more agents 40 so that appropriate performance interventions can be assigned to address those gaps. Analyzing one or any combination of performance metrics can determine the need for performance interventions. For example, if an agent's revenue per call is below average, then the intervention delivery system 430 could elect to deliver sales tips.

The agent profiles database 449 includes agent performance indicators for each agent 40. Performance indicators for an agent 40 are metrics of that individual agent's actual on-the-job performance. Performance indicators include quality, call handling time, first call resolution, cross-sell statistics, quality, close ratio, revenue per hour, revenue per call, calls per hour, and speed of answer, for example. Agent performance reflects an aspect of an agent's demonstrated service of a real contact.

The agent profiles database 449 also includes agent qualifications data for each agent 40. Agent qualifications are distinct from agent performance. Agent qualifications reflect characteristics of an agent 40. Although agent qualifications are sometimes correlated to on-the-job performance, agent qualifications are not necessarily correlated to performance. For example, an agent who is highly trained on the technical aspects of diamonds may be an inept diamond seller as measured by actual, on-the-job performance. Agent qualifications include an agent's innate traits such as cognitive skills and personality. Agent qualifications also include an agent's skills and competencies. Foreign language fluencies, product expertise acquired by receiving performance interventions involving specific products, and listening skills are examples of an agent's skill and competency qualifications.

The intervention delivery system 430 and the agent performance evaluator 410 update the agent profile database 449 when new information is available from the various computer-based components in the contact center 400. In one embodiment of the present invention, the agent profiles database 449 preferentially includes real-time data regarding agent qualifications and performance indicators such as agent parameters data 450.

The term “agent parameters” as used herein refers to any characteristic of an agent 40 that is pertinent to performance intervention delivery. Agent performance, agent qualifications, work schedules, successful completion of performance interventions, time since last intervention, and performance intervention assignment are examples of agent parameters.

An agent's ability to impact the operational effectiveness of the contact center 400 is another example of an agent parameter. Agent parameters can also include an estimate or other indication of the benefit that the contact center 400 is likely to derive from delivering a performance intervention to a specific agent 40. In other words, delivering a performance intervention to an agent 40 should benefit the contact center by improving the contact center's long-term operational effectiveness. An agent parameter can be a relative or absolute characterization of such improvement or benefit.

An agent 40 who is a poor performer may realize significant performance improvement from one or more performance interventions. This may be especially true for new-hire agents who have high cognitive abilities and desire to excel. In contrast, a senior agent 40 who is a strong performer may gain only modest benefit from a performance intervention, especially if the performance intervention is not geared towards advanced instruction. Thus, selecting poor performers to preferentially receive performance interventions can benefit the contact center 400 as a whole. Nevertheless, certain poor performers may achieve little or no performance gain from an extensive regime of performance interventions. In other words, the agent population 40 may include agents 40 with a low propensity to improve with training or other performance interventions. An agent parameter that describes benefit to the contact center 400 derived from delivering a performance intervention to a specific agent 40 can reflect agent trainability as well as other considerations.

“Intervention assignment” or “performance intervention assignment” refers to the interventions that are assigned to be delivered to one or more agents 40.

The intervention delivery system 430 accepts performance monitoring input from the agent performance evaluator 410 via the agent profiles database 449 as feedback for agent performance intervention programs, such as training programs. In one embodiment of the present invention, the intervention delivery system 430 is a training system that delivers instructive content to agents 40. In one embodiment of the present invention, the intervention delivery system 430 is a CBT system that is implemented in software and coupled to the contact center's communications network 54. Under the control of the Intervention Manager 460, the intervention delivery system 430 delivers intervention content in a manner that promotes both the short- and long-term performance of the contact center 400. Furthermore, the intervention delivery system 430 delivers content to agents 40 at times when those agents are available and when the performance intervention will not adversely impact the contact center's operations.

The intervention delivery system 430 is also in communication with the agent performance evaluator 410 through the Intervention Manager 460 so that appropriate intervention content, such as training materials, may be delivered to the agents 40 who are most in need of receiving a performance intervention. Proficient agents 40 are thus spared the distraction of unneeded performance interventions, and interventions can be concentrated on those agents 40 most in need and on areas of greatest need for those agents 40. Contact center management may establish pass/fail or remediation thresholds to enable the assignment of appropriate performance interventions to appropriate agents 40. This functionality is provided within the Intervention Manager 460. Preferably, agent skills that are found to be deficient relative to the thresholds are flagged and stored in a storage device within the agent profiles 42.

The intervention delivery system 430 can assess various aspects of an agent's qualifications. By administering a traits test, the intervention delivery system 430 characterizes an agent's personality and cognitive abilities. A traits test is typically only administered once for each agent 40, since for most agents 40, cognitive ability and personality do not change dramatically during employment. By administering a skills and competencies test, the intervention delivery system 40 can identify knowledge gaps and determine agent qualifications that improve with training and on-the-job experience.

With an understanding of agent's skills and competencies, performance interventions can be administered to improve skills and competencies. Once the performance intervention is administered, an assessment can be provided to ensure the agent 40 understood and retained the content. In addition, the agent's performance can be monitored to determine if performance has changed based upon the acquisition of the new information. When the agent's performance has changed, the intervention delivery system 430 can automatically update the agent's skills and competencies in the agent profiles database 449, thereby maintaining an up-to-date view of agent qualifications. Similarly, the intervention delivery system 430 maintains an intervention profiles database 469 that holds intervention parameters 470 and other descriptive information regarding each performance intervention in the contact center's portfolio of performance interventions.

The term “intervention parameter” as used herein refers to any attribute of an intervention that is pertinent to intervention delivery. Examples of intervention parameters include length of intervention, priority of intervention, and requirement to deliver the intervention by a deadline.

In tandem with the agent performance evaluator 410, the intervention delivery system 430 can determine if an agent 40 effectively practices the subject matter of a completed performance intervention, such as a training session. Immediately following a computer-administered test, the results are available throughout the contact center's information network infrastructure 54.

Coupled to the information infrastructure 54 of the contact center 400, the Intervention Manager 460 accesses information from components and computer systems throughout the center 400 to ascertain the dynamic operating conditions of the center 400. Thus, the Intervention Manager 460 receives contact center state 432, agent parameter information, and intervention parameters 470 via the contact center network 54. The Intervention Manager 460 processes this information according to management input 480 using software algorithms to determine parameters for managing the delivery of performance interventions to contact center agents 40.

The Intervention Manager 460 computes the rate of delivering performance interventions to agents 40 based on these inputs, 432, 449, and 470, and management input 480. The number of performance interventions delivered for an increment of time is a function of contact center state 432. The intervention delivery system 430 implements the delivery of performance interventions according to the rate set by the Intervention Manager 460.

If contact center state 432 indicates that contact center operations are below a desired level 480, such as a management input performance target 480, the Intervention Manager 460 decreases the rate of performance intervention delivery. Decreasing the rate of performance intervention delivery increases the number of agents 40 who are available to service contacts, thereby improving operational effectiveness and efficiencies.

If contact center state 432 indicates that the performance of the contact center 400 is higher than required, the Intervention Manager 460 increases the rate of performance intervention delivery, thereby diverting agents 40 from servicing contacts and engaging them to receive performance interventions. In this manner, the contact center 400 enhances the capabilities of its agents 40 without compromising the center's short-term performance.

In addition to setting the rate of performance intervention delivery, the Intervention Manager 460 selects the performance interventions that the performance intervention delivery system 430 delivers to agents 40. To make the selection, the Intervention Manager 460 compares state 432 of the contact center 400 to intervention parameters 470 and management input 480. Using contact center state 432 as a factor in selecting interventions provides responsiveness to dynamic conditions in the contact center 400.

The Intervention Manager 460 computes the selection of performance interventions based on intervention priority, which is an intervention parameter 470, one or more state levels 480, which are management inputs 480, and contact center state 432, such as operational performance. The Intervention Manager 460 can also select interventions based on other intervention parameters 470, such as intervention length or intervention cost. Furthermore, the Intervention Manager 460 can select performance interventions that best serve the operational effectiveness of the contact center 400. For example, the Intervention Manager 460 can select one performance intervention over another intervention based on an estimate that the selected performance intervention will yield more benefit to the contact center 400.

At any time, the contact center 400 typically maintains a list of performance interventions for which delivery is desirable. The performance interventions in the list have a range of priorities, or importance of delivery. In other words, delivery is critical for certain performance interventions and less important for others.

Intervention priority is typically set by management to define the relative importance or time-sensitive aspects of certain performance interventions relative to other others. For example, in advance of a seasonal sales flurry, such as selling flowers for Valentines Day, management may elect to define a flower-selling instructional session as a critical-priority performance intervention.

If performance 432 of the contact center 400 is lower than desirable, the Intervention Manager 460 can elect to deliver only performance interventions having critical delivery requirements. Consequently, when the contact center 400 is not operating as smoothly as desired, the Intervention Manager 460 avoids unnecessarily diverting an agent 40 from servicing contacts to receiving performance interventions. This function promotes the short-term performance of the contact center 400. When the contact center 400 is operating better than required, the Intervention Manager 460 is more liberal in its selection of performance interventions.

The contact center performance levels 480 that are thresholds for selecting performance interventions based on priority are management inputs 480. Personnel in the contact center 400 typically set these levels 480 according to managerial objectives; however, a computer algorithm can also define and/or adjust the state level settings 480. In other words, either a human or a machine in the contact center 400 can provide management input 480 to the Intervention Manager 460.

In addition to selecting performance interventions and pacing intervention delivery, the Intervention Manager 460 selects agents to receive performance interventions based on agent need. The Intervention Manager 460 can elect to deliver performance interventions on a priority basis to low-performing agents 40. Concentrating performance interventions on low-performance agents 40 typically increases the aggregate performance of the agent population 40 more than evenly distributing performance interventions amongst the agent population 40. That is, the Intervention Manager selects agents 40 to receive performance interventions to serve the operational goals of the contact center 400 as a whole.

In one embodiment of the present invention, the Intervention Manager's agent selection includes a sequence of agents 40 to receive performance interventions. For example, the sequence follows the ranked order of agent performance, starting with the lowest performing agent 40 and progressively sequencing towards the best performer. The intervention delivery system 430 receives the sequence from the Intervention Manager 460 and delivers performance interventions accordingly.

Those skilled in the information-technology, computing, or contact center arts will recognize that the components, data, and functions that are illustrated as individual blocks in FIG. 4 and discussed above are not necessarily well defined modules. Furthermore, the contents of each block are not necessarily positioned in one physical location of the contact center 400. In one embodiment of the present invention, the blocks represent virtual modules, and the components, data, and functions are physically dispersed. For example, in one embodiment of the present invention, the contact center state 432, the agent parameters 450, the agent availability data 435, the agent schedules 440, and the intervention parameters 470 are all stored on a single computer readable medium that can be offsite of the contact center 400 and accessed via a WAN.

In one embodiment of the present invention all of the computations and algorithms related to managing performance intervention delivery are stored on a single computer readable medium and executed by a single microprocessor. In yet another embodiment, multiple contact center components each execute one or more steps in the intervention management process. In general, the present invention can include processes and elements that are either dispersed or centralized according to techniques known in the computing and information-technology arts.

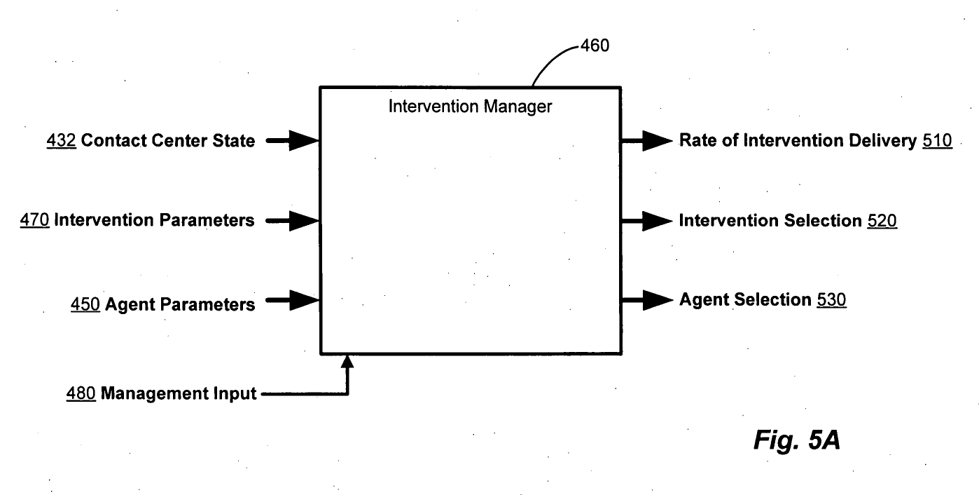

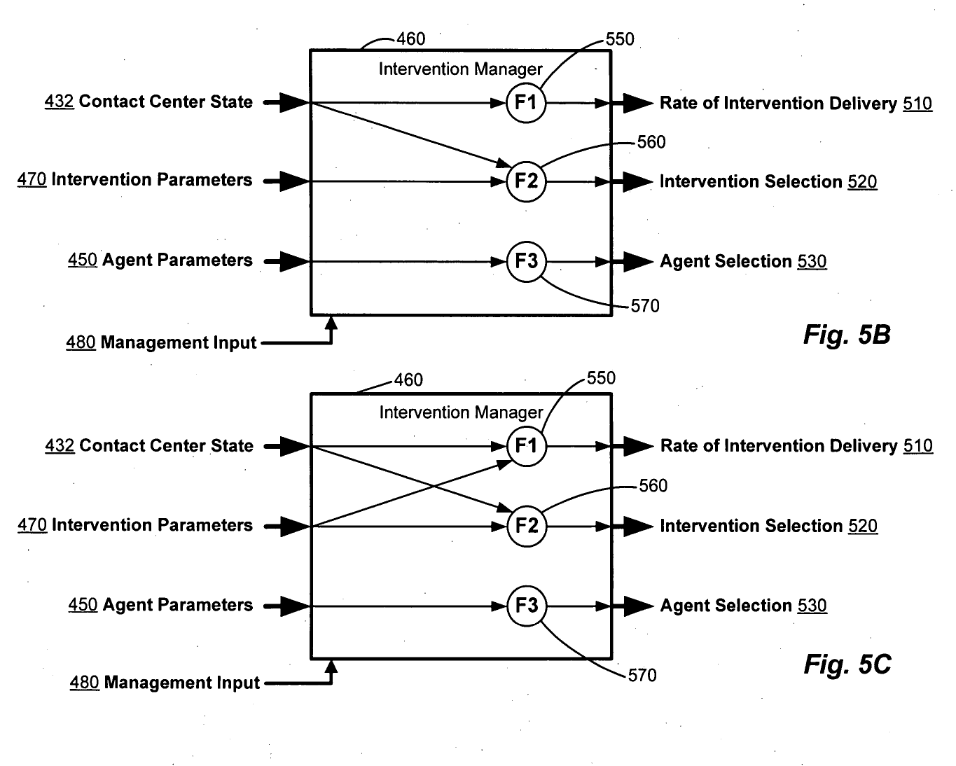

The present invention includes multiple computer programs which embody the functions described herein and illustrated in the exemplary flow charts and graphs and diagrams of FIGS. 5-15. However, it should be apparent that there could be many different ways of implementing the invention in computer programming, and the invention should not be construed as limited to any one set of computer program instructions. Further, a skilled programmer would be able to write such a computer program to implement the disclosed invention without difficulty based on the exemplary data tables and flow charts and associated description in the application text, for example.

Therefore, disclosure of a particular set of program code instructions is not considered necessary for an adequate understanding of how to make and use the invention. The inventive functionality of the claimed computer program will be explained in more detail in the following description in conjunction with the remaining figures illustrating the functions and program flow.

Certain steps in the processes described below must naturally precede others for the present invention to function as described. However, the present invention is not limited to the order of the steps described if such order or sequence does not alter the functionality of the present invention. That is, it is recognized that some steps may be performed before or after other steps or in parallel with other steps without departing from the scope and spirit of the present invention.

FIG. 5A illustrates primary inputs and primary outputs of an Intervention Manager 460 according to one exemplary embodiment of the present invention. Contact center state 432, intervention parameters 470, and agent parameters 450 are primary inputs to the Intervention Manager 460. The Intervention Manager 460 processes these three primary inputs, 432, 450, and 470, to provide three primary output parameters, 510, 520, and 530, to the intervention delivery system 430, which responds accordingly. In other words, the Intervention Manager 460 controls performance intervention delivery by outputting controlling inputs 510, 520, 530 to the intervention delivery system 430. The primary inputs, 432, 470, and 450, and the primary outputs, 510, 520, and 530, of the Intervention Manager 460 can each be a single value or an array of values, such as a vector or a matrix of numbers.

Contact center state 432, the first of the three primary inputs 432, 470, 150 to the Intervention Manager 460, is a measurement of operational performance in the contact center 400, according to one embodiment of the present invention. Exemplary performance metrics include average wait time and percentage of calls connected to an agent 40 within a preset period of time, such as twenty seconds. In another embodiment of the present invention, contact center state 432 is a measurement of load, or call volume.

Intervention parameters 470, the second of the three primary inputs to the Intervention Manager 460, are attributes of each performance intervention that are pertinent to intervention delivery. In one embodiment of the present invention, the priority of each performance intervention is the intervention parameter 470 that the Intervention Manager 460 uses for its output computations. That is, a performance intervention's priority designates the importance of delivering that intervention, and the Intervention Manager 460 manages intervention delivery based on that priority designation.

Priority categories, such as critical, high, medium, and low categories, designate performance interventions with similar delivery importance. Alternatively, the contact center's management prioritizes performance interventions by ranking each performance intervention according to the relative importance of its delivery. An index value can represent this ranking. In one embodiment of the present invention, a continuous scale specifies the priority of each performance intervention.

In addition to priority, intervention parameters 470 can include performance interventions assignments, intervention content, and intervention length. For example, management may assign performance interventions to specific agents 40. Intervention content can include the subject matter of a training session, such as instructing agents 40 to sell roses to contacts who are placing incoming calls to the contact center 400 during the Valentines season.

Agent parameters 450, the third of three primary inputs 432, 470, 450 to the Intervention Manager 460, includes the aspects of each agent 40 that are pertinent to performance intervention delivery. Agent parameters 450 include agent performance. In one embodiment of the present invention, agent performance includes each agent's ranked performance. That is each agent 40 is assigned a number that ranks his/her ordered performance, spanning from best to worst. Agent parameters 450 also include a list of the performance interventions that each agent 40 has previously received. In one embodiment of the present invention, agent parameters can also include each agent's work schedule 440, which is available from the WFM component 48. Agent parameters 450 can also include skills and competencies and traits.

Rate of performance intervention delivery 510, the first of the three primary outputs from the Intervention Manager 460, is the number of performance interventions delivered over an arbitrary increment of time, such as per second, minute, hour, day, or shift. This primary output 510 sets the frequency with which the intervention delivery system 430 delivers performance interventions. The rate of performance intervention delivery 510 measures the number of performance interventions for which delivery is initiated. Alternatively, the rate of performance intervention delivery 510 measures the number of performance interventions completed.

Intervention selection 520, the second of the three primary outputs from the Intervention Manager 460, is the determination of which performance interventions are delivered by the intervention delivery system 430 to at least one agent 40. In one embodiment of the present invention, performance intervention selection 520 is a subset of performance interventions assigned for delivery by management of the contact center 400. In one embodiment of the present invention, intervention selection 520 specifies a group of performance interventions, such as a prioritization category. That is, intervention selection 520 can instruct the intervention delivery system 430 to select a critical, a high, a medium, or a low priority performance intervention for delivery. Furthermore, an intervention selection 520 can specify that the intervention delivery system 430 is to deliver multiple performance interventions that have a defined combination of priorities.

Agent selection 530, the third of the three primary outputs from the Intervention Manager 460, is the determination of the agents 40 to whom the intervention delivery system 430 delivers performance interventions. In one embodiment of the present invention, agent selection 530 is an ordered sequence of agents 40. Agent selection can also be based on a worst-to-best ordered ranking of agents, the time lapse since each agent received a performance intervention, or the ages of performance intervention assignments. For example, an agent 40 who was assigned a performance intervention several weeks earlier can receive his/her performance intervention rather than another agent 40 who received the performance intervention a few hours earlier.

The Intervention Manager 460 also includes provisions to accept management inputs 480. Management inputs 480 are settings that adjust the Intervention Manager's computations and algorithms. That is, management input 480 is a vehicle to modify or define the functional relationships between the primary inputs 432, 470, 450 and the primary outputs 510, 520, 530 of the Intervention Manager 460. In one embodiment of the present invention, the contact center's personnel enter the management inputs 480 through a computer terminal. In another embodiment of the present invention, one or more of the contact center's computer-based systems automatically compute and provide the management input 480 to the Intervention Manager 460.

In one embodiment of the present invention, management input 480 is a contact center state level 480. The Intervention Manager 460 compares the primary input contact center state 432 to the contact center state level 480 and adjusts at least one of the primary outputs 510, 520, 530 on the basis of the comparison.

FIG. 5B illustrates functional relationships between the three primary inputs 432, 470, 450 and the three primary outputs 510, 520, 530 of the Intervention Manager 460 according to one embodiment of the present invention. Function F1 550, Function F2 560, and Function F3 570 describe the algorithms through which the Intervention Manager 460 computes intervention delivery parameters 510, 520, 530, which are output to the intervention delivery system 430.

As illustrated in FIG. 5B, the Intervention Manager 460 computes the rate of performance intervention delivery 510 on the basis of contact center state 432 using Function F1 550. That is, contact center state 432 is the primary input variable that algorithm F1 550 uses to compute the rate of performance intervention delivery 510. Management input 480 is another input to the F1 algorithm 550. Contact center personnel can enter a contact center state level 480 into the Intervention Manager 460 as management input 480. Algorithm F1 550 increases the rate 510 of performance intervention delivery 510 when measured contact center state 432 falls below the state level 480 and decreases the rate 510 when measured state 432 rises above the state level 480.

Function F2 560 computes the selection 520 of performance interventions based on contact center state 432 and intervention parameters 470. According to an exemplary embodiment of the present invention, this function 560 is an algorithm 560 that compares the state 432 of the contact center 400 to one or more state levels 480, which are management inputs 480. The algorithm 560 applies rules to the results of the comparison to determine the characteristics of the performance interventions that are to be delivered to agents 40. To select specific performance interventions with these characteristics, the Intervention Manager 460 searches the performance interventions that are eligible for delivery and identifies one or more matches. A performance intervention is typically eligible for delivery if it is assigned to at least one agent 40.

In an exemplary embodiment, the Function F2 algorithm 560 includes rules that determine a suitable priority 520 of intervention that should be delivered based on the state 432 of the contact center 400. For example, if the contact center's performance 432 is within a certain performance band 480, the rules restrict intervention delivery to interventions having a specified priority category that corresponds to the band. Applying the specified priority 520 to the intervention parameters 470 of eligible performance interventions, the algorithm 560 identifies a performance intervention having a suitable priority. The intervention delivery system 430 then delivers the identified performance intervention to one or more agents 40.

Function F3 570 computes the selection 530 of agents 40 who are to receive performance interventions. In one embodiment of the present invention, the Intervention Manager 460 coordinates selecting agents 40 with determining intervention delivery rate 510. In another embodiment of the present invention, the Intervention Manager 460 coordinates selecting agents 40 with selecting performance interventions. In yet another embodiment of the present invention, the Intervention Manager 460 coordinates selecting agents both with selecting performance interventions and with determining intervention delivery rate 510. In other words, the Intervention Manager 460 can coordinate Function F3 370 with Function F2 560, with Function F1 550, or with Function F2 560 and Function F1 550.

To select agents 530 to receive performance interventions, Function F3 570 accesses agent parameters 450 to determine which agents 40 have the greatest need for performance interventions. In one embodiment of the present invention, the Intervention Manager 460 correlates agent need for performance intervention to agent performance. The Intervention Manager 460 ascertains agent performance from the agent performance evaluator or from agent profiles database 449.

FIG. 5C illustrates the input-to-output functional relationships of the Intervention Manager 460, according to another embodiment of the present invention. In this embodiment, the rate of intervention delivery 510 is a function not only of the contact center state 432, but also of intervention parameters 470, such as intervention priority. In this embodiment, the Intervention Manager 460 can elect to accelerate the delivery of performance interventions when intervention parameters 470 warrant such accelerated delivery. For example, the contact center 400 may face a deadline to deliver one or more performance interventions that are time sensitive or otherwise critically important. The Intervention Manager 460 can respond to meet the deadline by increasing the number of performance interventions delivered during a time period preceding the deadline.

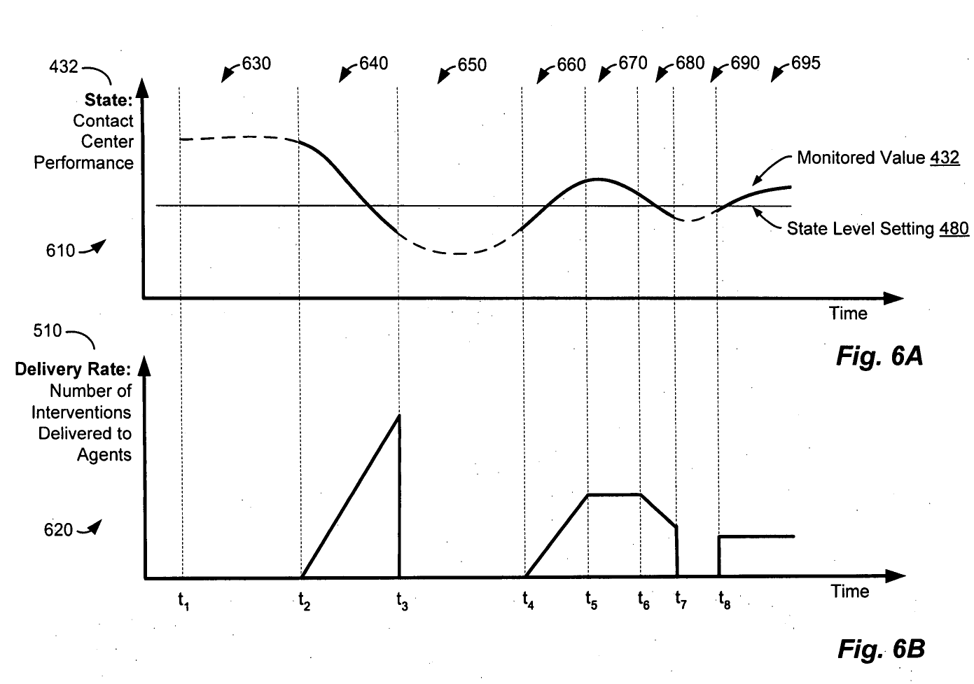

FIG. 6 illustrates the Intervention Manager 460 adjusting the rate of delivering performance interventions according to one exemplary embodiment of the present invention. The upper graph 610 presents monitored contact center state 432 and a management-input state level setting 480 over time. In this embodiment, contact center state 432 is contact center performance 432. In other words, the graph 610 illustrates the measured operational performance 432 of a contact center 40 as compared to a certain level 480. Without defining a specific metric of contact center performance 432, this graph 610 illustrates representative fluctuations of any of the contact center performance variables described herein. Furthermore, the upper graph 610 also illustrates contact center performance 432 responding to intervention delivery by the intervention delivery system 430 under management by the Intervention Manager 460.

The lower graph 620 illustrates the rate of intervention delivery 510 as set by the Intervention Manager 460 in response to the conditions illustrated in the upper graph 610. In other words, the lower graph 620 depicts the Intervention Manager 460 adjusting the rate of intervention delivery based on the monitored performance 432 of the contact center 400.

Together, the two graphs 610, 620 illustrate the interaction between the Intervention Manager 460 and the operating conditions 432 of the contact center 400, wherein operating conditions 432 are characterized by contact center state 432. That is, the graphs 610, 620 illustrate an exemplary sequence of actions and reactions between the Intervention Manager 460 and the operations of the contact center 400.

In one embodiment of the present invention, the Intervention Manager 460 controls the performance 432 of the contact center 400 with closed loop control using monitored performance 432 as feedback for adjusting the rate 510 of intervention delivery. That is, in one embodiment, the present invention monitors the current performance 432 of the contact center 400 and dynamically manipulates the number 510 of performance interventions delivered in an increment of time so as to control performance 432 to a desired level 480.

At the time period 630 between t₁ and t₂, contact center performance 432 is significantly above a performance level setting 480, which is a management input 480. These conditions suit the delivery of performance interventions, since at least some agents 40 can be diverted from servicing contacts while maintaining acceptable contact center performance 432. At time t₂, the Intervention Manager 460 elects to initiate delivering performance interventions. Manual intervention by contact center personnel, such as by an administrator or a manager, can prompt this initiation. Alternatively, either the Intervention Manager 460 or another computer-based system in the contact center 400 can trigger the delivery of performance interventions at time t₂.

At time t₂, the Intervention Manager 460 begins ramping the rate 550 of delivering performance interventions. That is, in the time period 640 between time t₂ and time t₃, the Intervention Manager 460 progressively increases the number 510 of interventions delivered per increment of time from zero upward. As agents 40 suspend servicing contacts and begin receiving performance interventions, monitored contact center performance 432 declines and ultimately falls below the management input state level setting 480.

At time t₃, the Intervention Manager 460 determines that contact center state 432 has fallen unacceptably below the state level setting 480 and ceases delivering performance interventions. In one embodiment of the present invention, ceasing delivering performance interventions entails terminating performance interventions that are in progress. Such termination can follow a specific agent sequence. The agent termination sequence can proceed according to management input, last-in-first-out, first-in-last-out, worst-agent-to-best-agent, time since last performance intervention, or other formula. In an alternative embodiment, ceasing initiating new performance interventions curtails the rate 550 of intervention delivery, for example smoothly decreasing the rate of delivering performance interventions until contact center state 432 recovers to an acceptable level 480.

At time t₃, the rate 510 of performance delivery is higher that the current conditions of the contact center 400 can support while maintaining an acceptable level 480 of operational performance. One or multiple factors can contribute to such unacceptable operational performance at time t₃. For example, an unexpected spike in call volume during the time frame 640 might cause hold time to increase unacceptably. A random increase in the length of time required to service contacts during the time frame 640 might cause wait time to increase, even with constant call volume. Even with constant contact center conditions during the time frame 640, the Intervention Manager 640 increasing the deliver rate 510 too aggressively might cause unacceptable performance.

Regardless of the cause of the unacceptable performance, the graphs 610, 620 illustrate the Intervention Manager 640 adapting to unacceptable performance and implementing corrective action by changing the rate 510 of delivering performance interventions to zero at time t₃.

During the time period 650 between time t3 and time t4, performance 432 of the contact center 400 recovers as the center's operations respond to the Intervention Manager 460 reducing the rate 510 of intervention delivery. After the Intervention Manager 460 changes the rate 432 to zero at t₃, performance 432 continues to decline before peaking at a minimum value and then improving. The time delay between setting the rate 510 to zero and the state 432 recovering may be due to interventions that are already in the delivery pipeline at time t₃.

At time t₄, contact center performance 432 is improving strongly towards passing the state level setting 480. At this point, the Intervention Manager 460 elects to reinitiate delivering performance interventions. During the time period 660 between time t₄ and time t₅, the Intervention Manager 460 ramps the rate 510 of delivering performance interventions more gradually than during the time period 640 between t₂ and t₃. This adjustment of the ramp slope illustrates the Intervention Manager 460 adapting to the fluctuations in the dynamic responsiveness of the contact center 400.

At time t₅, the Intervention Manager 460 elects to deliver interventions at a constant rate. At the time period 670 between t₅ and t₆, contact center performance peaks and then begins to decline. By time t₆, performance 432 approaches the state level setting 480. At this point, the Intervention Manager 460 begins to taper off the rate 510 of intervention delivery.

The rate reduction continues during the time period 680 between time t₆ and time t₇. At time t₇, the Intervention Manager 460 determines that the rate reduction is insufficient to maintain desired performance and sets the rate 510 to zero. The insufficiency of the prescribed rate reduction might result from a perturbation in the number of incoming calls, for example.

During the time period 690 between time t₇ and time t₈, contact center performance 432 increases above the state level setting 480. At time t₈, the Intervention Manager 460 resumes delivering performance interventions. In one embodiment of the present invention, the Intervention Manager's algorithms 550 compute this rate 510 based on the contact center's response to previous rates 510. In other words, the Intervention Manager 460 can analyze and learn from the reactions of the contact center 400 to earlier performance intervention deliveries.

In the time 695 following time t₈, the Intervention Manager 460 delivers interventions at a constant rate 510. The performance 432 of the contact center 400 stabilizes to a level that is slightly above the state level setting 480. As conditions in the contact center 400 fluctuate beyond time t₈ and as managers update management inputs 480, the Intervention Manager 460 continues to adapt and respond accordingly. This flexible functionality serves both the need to maintain operational performance at an acceptable level and the need to enhance the performance capabilities of the contact center's staff of agents 40.

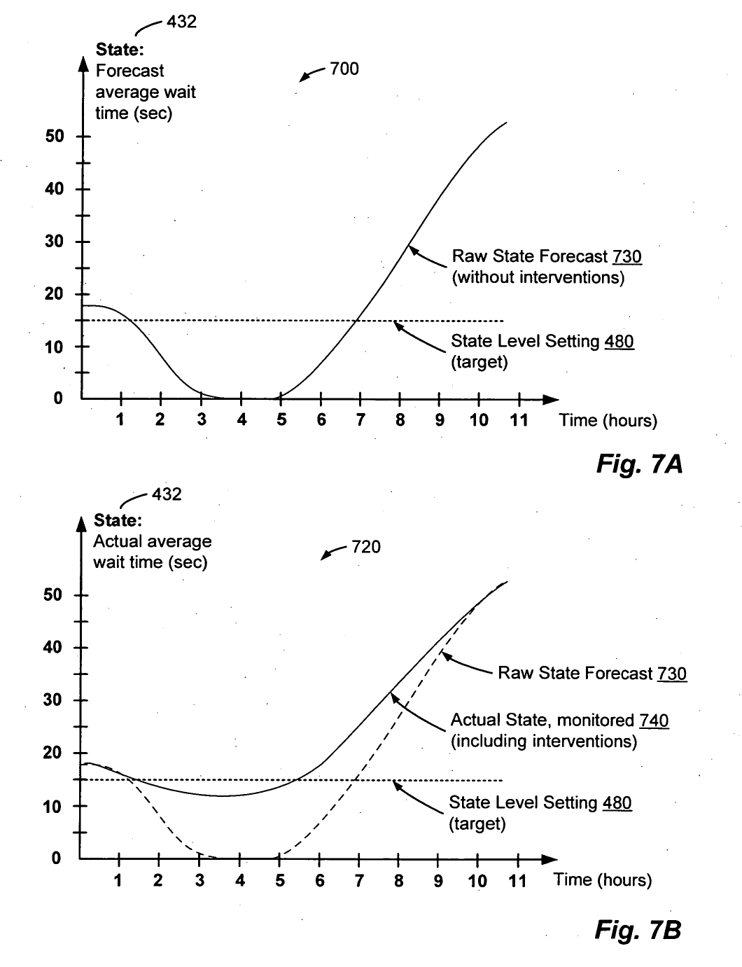

FIGS. 7A and 7B further illustrate the capabilities of the Intervention Manager 460 to adapt to changing conditions in the contact center 400 and to flexibly manage intervention delivery. These figures describe an embodiment of the present invention in which the Intervention Manager 460 manages intervention delivery based on forecasted contact center state 432.

FIG. 7A is a graph 700 that illustrates a projected state 432 of the contact center 400 from a current time, at hour zero, to eleven hours into the future. In this example, state 432 is average wait time, which is a performance metric that is typically a function of call volume. The graph 700 also presents a target state level 480, which is typically established through management input 480 and is set to the exemplary value of fifteen seconds. The target state level 480 is the level below which it is desirable to maintain average wait time. In other words, from a performance perspective, less wait time is better, and the Intervention Manager 460 controls intervention delivery so that wait time is less than fifteen seconds.

The illustrated forecast 730 of average wait time 432 is a raw forecast that does not include any change in average wait time 432 that may result from the delivery of interventions under management of the Intervention Manager 460. The forecast includes a time between hour one and hour seven during which the forecasted wait time falls significantly below the target level 480 of fifteen seconds. During this time, the Intervention Manager 460 has an opportunity to deliver interventions while maintaining acceptable wait time.

FIG. 7B is a graph 720 that presents the actual, monitored wait time 740 in conjunction with the raw wait time forecast 730 and the target wait time level 480 of the graph 700 illustrated in FIG. 7A. The combination of curves illustrates the Intervention Manager 480 using the lull in wait time as an opportunity to deliver performance interventions. In addition to establishing a rate 510 of delivering performance interventions, the Intervention Manager 460 can elect to take other managerial actions that will consume wait time 730. For example, the Intervention Manager 460 can use the lull as an opportunity to deliver longer performance interventions. Such actions can be taken in separately or in parallel with one another.

Between hours one and two, the Intervention Manager 460 begins delivering performance interventions or implementing other actions that consume the forecasted lull in wait time 730. Subsequently, the actual, monitored wait time 740 responds to the delivery of interventions and thereby increases. The actual wait time increases from a forecasted wait time 730 of zero seconds to an actual wait time 740 of approximately twelve seconds, which is acceptably below the target level 480 of fifteen seconds. In anticipation of the forecast rise in wait time that occurs after hour six, the Intervention Manager 460 can stop delivering performance interventions. After the Intervention Manager 460 stops delivering performance interventions, the monitored wait time 740 settles to overlay the forecast wait time 730 at approximately hour eleven.

As an alternative to stopping the delivery of new performance interventions when, at approximately hour six, monitored state 740 increases above the state level setting 480, the Intervention Manager 460 can opt to continue delivering time-sensitive performance interventions. For example, a critical performance intervention may need to be delivered before hour eleven. Although actual state 740 is unacceptable at hour seven, the forecast 730 indicates that state 740 will become progressively worse between hour seven and hour eleven. The Intervention Manger 460 can recognize that the conditions for delivery of the time-sensitive performance intervention are better at hour seven than any other time before hour eleven. In response, the Intervention Manager 460 can act to serve the contact center's operational effectiveness by rapidly delivering the time-sensitive performance interventions at hour seven.

FIGS. 7A and 7B illustrate the capabilities of the present invention to optimize resource utilization in the contact center 400 based on the forecasted availability of such resources. The depiction of state 432 in these figures as average wait time 432 is exemplary. In alternate embodiments of the present invention, the state forecast 432 and the state level 480 are direct measurements of call volume or any other form of call center state 432.

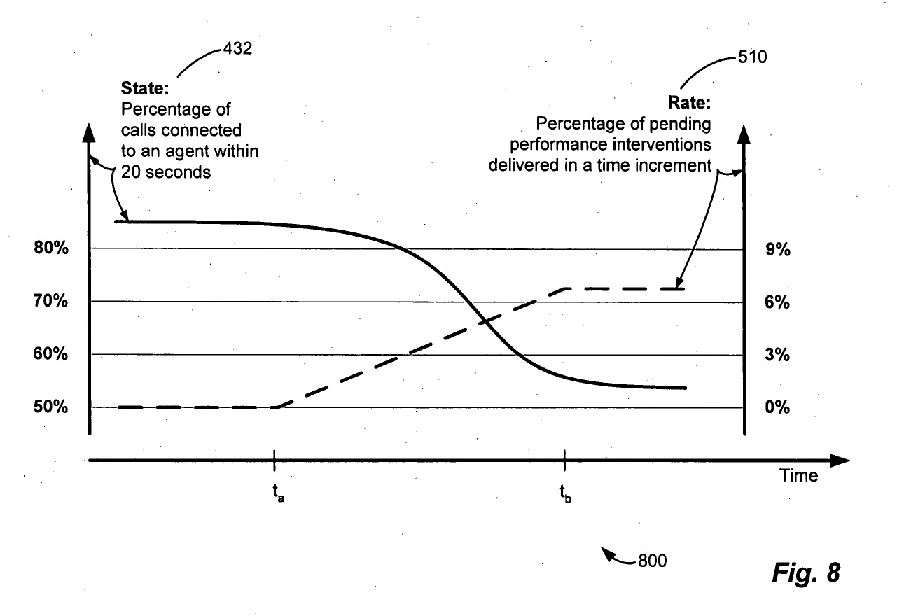

FIG. 8 is another graphical illustration of an exemplary embodiment of the Intervention Manager 460 responding to fluctuating conditions in a contact center 400. The graph 800 presents call center state 432 and rate 510 on a common timeline. In the embodiment supported by the illustrated functionality, state 432 is the percentage of calls connected to an agent 40 within the exemplary time of twenty seconds. Rate 510 is the percentage of pending performance interventions that are delivered in a time increment, such as an hour. In other words, rate 510 is the percentage of interventions that are delivered out of the total interventions that are eligible for delivery and for which delivery is sought.

Before time tₐ, over 80% of the calls connect to an agent 40 within twenty seconds, and the Intervention Manager 460 is not delivering any interventions. At time tₐ, the Intervention Manager 460 begins delivering interventions. Between time tₐ and time tₕ, the Intervention Manager 460 increases the rate 510 of intervention delivery from zero to seven percent. In response, the percentage of calls connected within twenty seconds falls to approximately 55%. At time t_{b}, the Intervention Manager 460 stops increasing the rate 510 of intervention delivery and holds it constant at seven percent for some period of time. Responsive to this steady seven-percent rate, the state 432 of the contact center 400 stabilizes to approximately 55%.

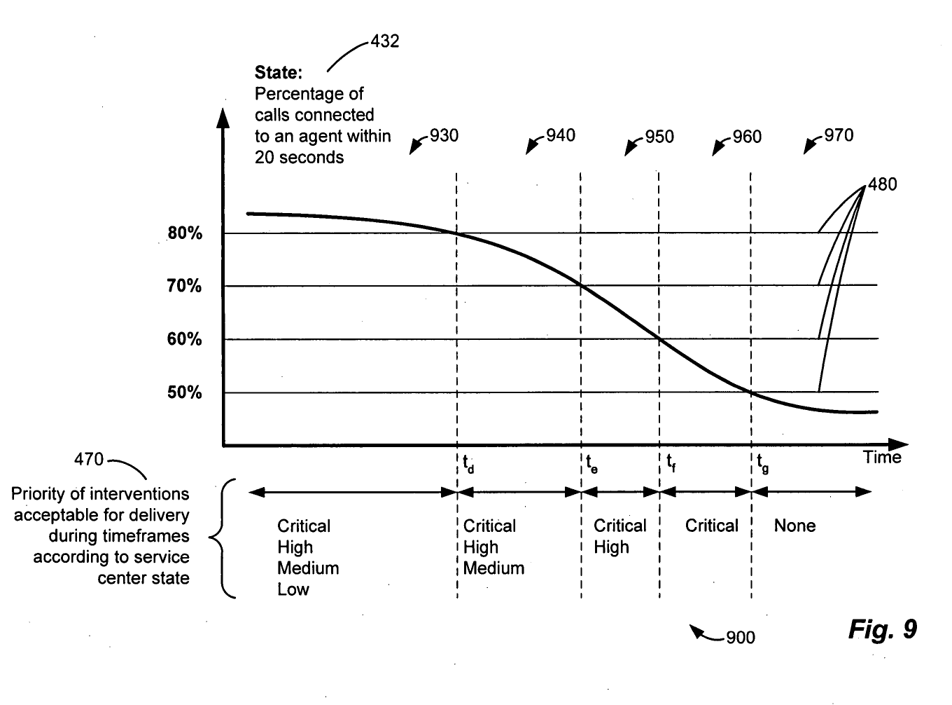

FIG. 9 graphically illustrates the functionality of the Intervention Manager 460 in selecting interventions based on the state 432 of the contact center 400 in accordance with an exemplary embodiment of the present invention. The illustrated graph 900 presents the percentage of calls connected to an agent 40 within twenty seconds, along an x-axis timeline. This measurement of state 432 can be a monitored value or a forecast. In the plotted time, state 432 transitions from approximately 83% to approximately 47%.

Based on management input 480, the Intervention Manager 460 maintains a table or similar data file that correlates acceptable intervention parameters 470 to state levels 480 defined by management input 480. The figure depicts intervention priority as an exemplary intervention parameter 470.

According to the table, the condition of 80% or more calls connected within twenty seconds, which is an exemplary time, satisfies the state-level criterion for delivering interventions having critical, high, medium, or low prioritization. For the time period 930 below time t_{d}, state 432 satisfies this criterion, and the Intervention Manager 460 may select a performance intervention for delivery from any of these prioritization levels if the intervention is assigned to at least one agent 40.

State 432 between 70% and 80% is the criterion for delivering critical-, high-, and medium-priority interventions. The state during time period 940 between time t_{d} and time tₑ satisfies this criterion. State 432 between 60% and 70% is the criterion for delivering critical-, and high-priority interventions. The contact center 400 meets this criterion between time tₑ and t_{f}, and the Intervention Manager 460 may elect to deliver interventions from either prioritization category during this time period 950. The table restricts the Intervention Manager 460 to delivering only critical interventions when state 432 is between 50% and 60%, as exhibited for the time period 960 between time t_{f} and time t_{g}. When state 432 falls below 50%, as it does after time t_{g}, the Intervention Manager 460 refrains from delivering interventions.

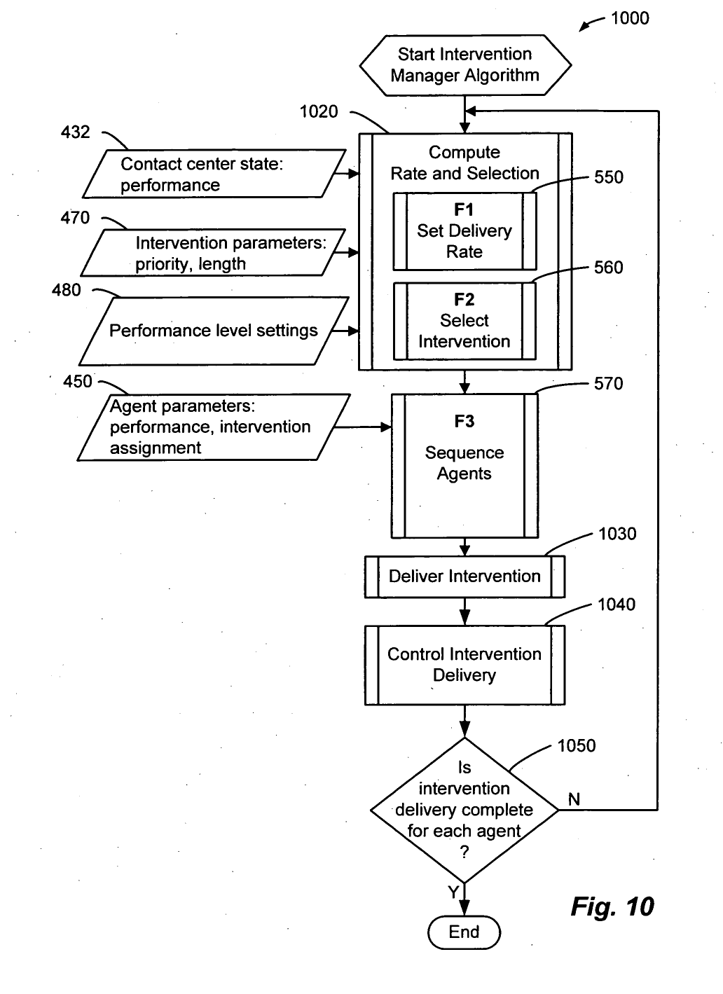

FIG. 10 illustrates an exemplary process for implementing the Intervention Manager 460 in accordance with an exemplary embodiment of the present invention. Algorithm 1000, titled Intervention Manager Algorithm, computes intervention delivery rate 510, intervention selection 520, and agent selection 530 as a function of contact center state 432, intervention parameters 470, agent parameters 450, and management input 480. Algorithm 1000 incorporates Function F1 550, Function F2 560, and Function F3 570, which are described above, to perform the computations. The Intervention Manager 460 provides the results of its computations to the intervention delivery system 430, which delivers interventions following these results.

The first step 1020 of the Intervention Manager Algorithm 1000 is a process 1020, titled Compute Rate and Selection, that includes Function F1 550 and Function F2 560, which are algorithms illustrated in subsequent figures. Compute Rate and Selection 1020 receives contact center state 432, intervention parameters 470, and performance level settings 480 via the contact center network 54 and uses these inputs 432, 470, 480 to compute the rate 510 of intervention delivery and the selection 520 of interventions. Function F1 550 is an algorithm, titled Set Delivery Rate, that computes the rate 550 of intervention delivery using the inputs 432, 470, 480. Function 2 560 is another algorithm, titled Select Intervention, that computes the selection of interventions using the inputs 432, 470, 480.

The next step of Algorithm 1000 is an algorithm 570 titled Sequence Agents that selects 530 agents 40 to receive performance interventions. The Sequence Agents algorithm 570 computes the selection using agent performance and intervention assignment, which are agent parameters 450, that are typically stored in the agent profiles database 449. The selection computation illustrated in FIG. 10 is an exemplary implementation of Function F3 570 illustrated in FIGS. 5A, B, and C and described above.

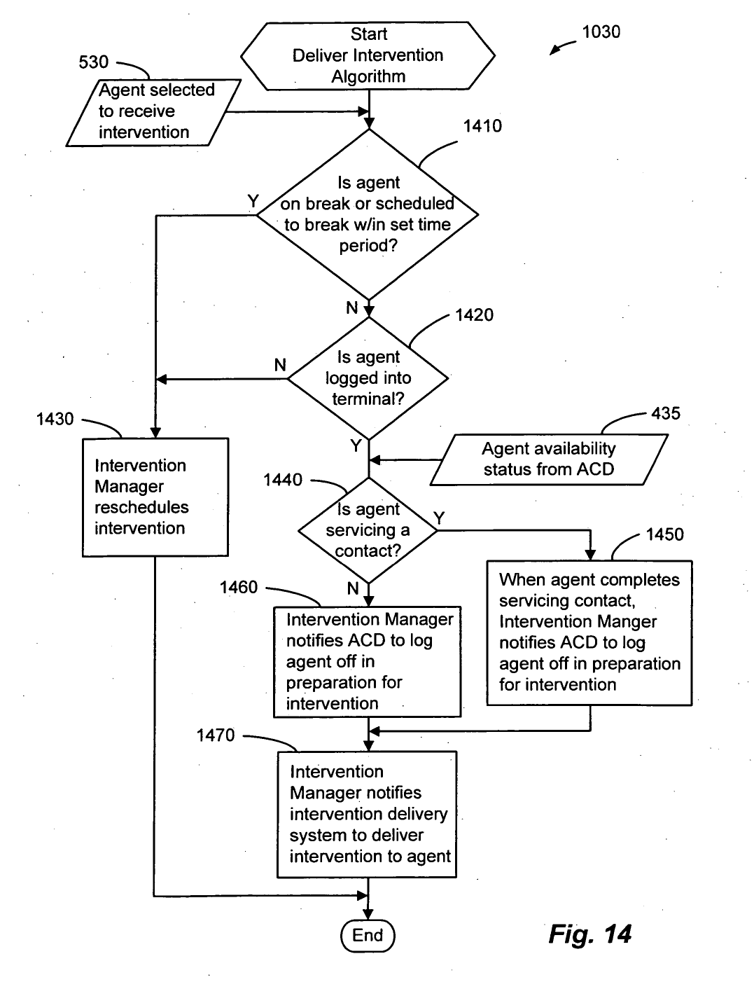

At Step 1030 of Algorithm 1000, the Intervention Manager 460 interacts with the intervention delivery system 430 to deliver interventions to the agents 40 selected in Sequence Agents 570. Deliver Intervention Algorithm 1030, which is illustrated in subsequent FIG. 14, includes functionality that communicates the status of the contact center's agents 40 to other personnel and systems in the contact center 400. Such communication supports coordinating processes in the contact center 400 to enhance operational efficiency of the center 400.

Following Step 1030, Algorithm 1000 calls Control Intervention Delivery 1040, which facilitates the Intervention Manager 460 interacting with the intervention delivery system while intervention delivery is underway. Through Algorithm 1040, the Intervention Manager 460 can elect to terminate intervention delivery if dynamic conditions in the contact center 400 warrant such termination. For example, if contact center performance 432 dips to an unacceptable level, Algorithm 1040 terminates intervention delivery so that additional agents 40 can service contacts and improve performance 432.

At decision Step 1050, the Intervention Manager Algorithm 100 iterates the previous steps in the algorithm flow for each agent 40 of the contact center 400 for whom intervention delivery is applicable. That is, Algorithm 1000 continuously repeats unless all pending interventions have been delivered to all eligible agents 40.

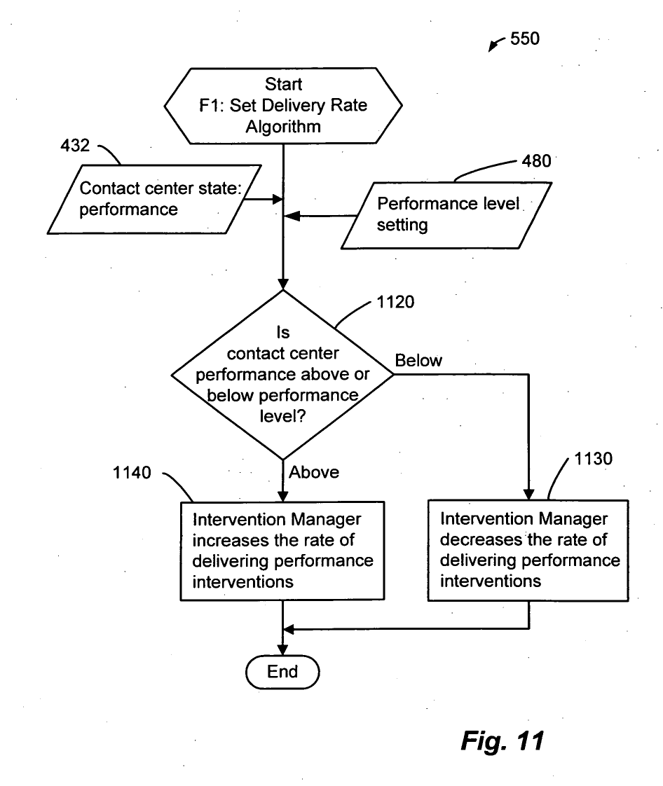

FIG. 11 is a flowchart 550 illustrating the flow and steps of an exemplary embodiment of the Set Delivery Rate Algorithm 550 presented in FIG. 10. The Intervention Manager Algorithm 1000 calls Algorithm 550 as part of its Compute Rate and Selection process 1020. Algorithm 550, as illustrated is FIG. 11, is also an embodiment of the F1 Function 550 depicted in FIG. 5B.

Exemplary algorithm 550 begins with receiving contact center state 432 in the form of contact center performance 432 and management input 480 in the form of a state level setting 480. In the exemplary algorithm 550, the state level setting 480 is a performance level setting 480. In other embodiments of the present invention, Set Delivery Rate Algorithm 550 uses any of the forms of contact center state 432 and state level settings 480 discussed herein.

At inquiry Step 1120, Algorithm 550 determines if contact center performance 432 is above or below the performance level setting 480. That is, the Intervention Manager 460 determines if the performance 432 of the contact center 400 is suitable to deliver performance interventions at a certain rate 510.

If performance 432 is above the state level setting 480, then at Step 1140, the Intervention Manager 460 instructs the intervention delivery system 430 to increase the rate 510 of delivering performance interventions. If performance 432 is below the state level setting 480, then at Step 1130, the Intervention Manager 460 notifies the intervention delivery system 430 to reduce the rate 510 of delivering performance interventions.

In one embodiment of the present invention, Algorithm 550 includes multiple performance level settings 480, each triggering a distinct rate 510. In one embodiment of the present invention, rate 510 is a function of the difference between the contact center performance 432 and a performance level setting 480. The computed rate 510 is related to the deviation between performance 432 and performance level setting 480. The algorithm 550 computes a specific rate 510 that is proportional to the magnitude of the difference between performance 432 and performance level setting 480.

In one embodiment of the present invention, the Intervention Manager 460 adjusts the performance level setting 480 to meet an intervention delivery goal of the contact center's management or other decision maker. In one embodiment, the Intervention Manager 460 notifies management if the current rate 510 of intervention delivery is insufficient to meet a managerial goal or deadline. If current constraints preclude delivering any performance interventions, then the Intervention Manager 460 notifies management that the performance level setting 480 needs adjustment, for example. In one embodiment of the present invention, the Intervention Manager 460 can elect to automatically adjust the performance level setting 480.

In one embodiment of the present invention, the Intervention Manager 460 computes intervention delivery rate 510 based on one or more intervention parameters 470. FIG. 5C, which is discussed above, illustrates an embodiment in which Function F1 550 of the Intervention Manager 460 computes rate 510 on the basis of contact center state 432, management input 480, and intervention parameters 470.

For an embodiment as illustrated in FIG. 5C, priority of intervention delivery is an intervention parameter 470 that affects the determination of delivery rate 510. The Intervention Manager 460 can take measures to expedite the delivery of critical priority interventions. For example, the Intervention Manager 460 can accelerate intervention delivery when the intervention profiles database 449 specifies that specific performance interventions have critical delivery requirements.

In one embodiment of the present invention, management can enter, as management input 480, a deadline to deliver one or more specific performance interventions. The Intervention Manager 460 monitors progress towards meeting the deadline. If, as the deadline approaches, the Intervention Manager 460 determines that the existing rate 510 of intervention delivery is insufficient to meet the deadline, then the Intervention Manager 460 increases the rate 510 of intervention delivery.

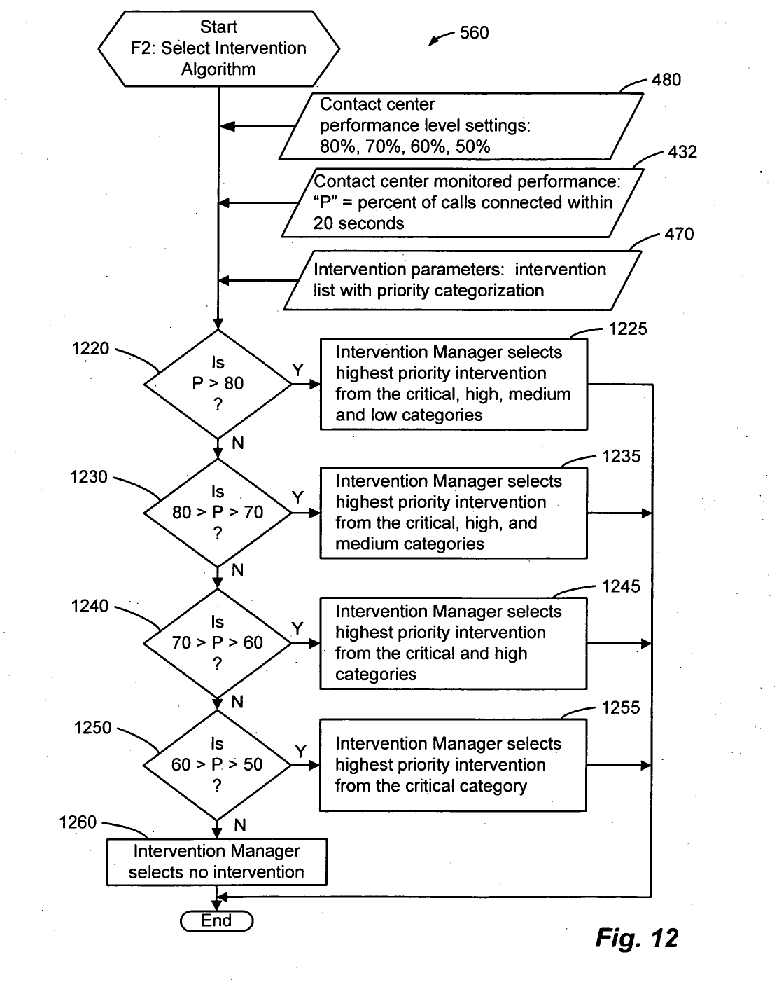

Referring now to FIG. 12, after the Intervention Manager Algorithm 1000 determines the rate 510 of intervention delivery, it calls Select Intervention Algorithm 560 to select one or more specific performance interventions for delivery. Algorithm 560 is an exemplary embodiment of Function F2 560, which is depicted in FIG. 5B and FIG. 5C. The flowchart 560 includes logic and computations that implement the functionality illustrated in FIG. 9. That is, FIG. 12 illustrates the algorithms behind the functionality depicted in FIG. 9 and is generally consistent with FIGS. 5B and 5C.

Algorithm 560 performs the intervention selection 520 on the basis of performance level settings 480, contact center performance 432, and intervention prioritization. This data 480, 432, and 470 is available from management input 480, the ACD 32, and intervention profiles database 469 respectively.

At inquiry Step 1220, Algorithm 560 determines if contact center performance 432 is above a management input performance level setting 480. More specifically, Step 1220 determines if more that 80% of the calls into the contact center 400 are connected to an agent 40 within twenty seconds, which is an exemplary time. If the determination is positive, at Step 1225 Algorithm 560 selects a performance intervention having a critical, high, medium, or low categorization. In other words, when contact center performance 432 is at its highest level, performance intervention selection 560 is not constrained to a specific intervention priority. At this performance, the Intervention Manager 460 can elect to deliver any performance intervention that is assigned to at least one agent 40.

At inquiry Steps 1230, 1240, and 1250, Algorithm 560 determines if contact center performance 432 is between 80% and 70%, between 70% and 60%, or between 60% and 50% respectively. If performance 432 is less than or equal to 80% and greater than 70%, Select Intervention 560 executes Step 1235 to select a critical-, high-, or medium-category performance intervention. Performance 432 less than or equal to 70% and greater than 60% is the criterion for Algorithm 560 to select a performance intervention from the critical and high categories of performance interventions. For performance less than or equal to 60% and greater than 50%, Step 1255 limits the Intervention Manager 460 to selecting performance interventions that are designated as critical. If the contact center 400 connects 50% or fewer calls to an agent 40 within twenty seconds, then, at Step 1260, Algorithm 560 does not select any performance interventions for delivery until performance 432 improves.

If Algorithm 560 determines that the performance 432 of the contact center 400 is such that multiple performance interventions meet the selection criterion and thus qualify for delivery, then the Intervention Manager 460 can select one or more specific interventions from the qualifying group. That is, of the performance interventions that are assigned to at least one agent 40 two or more may qualify for delivery based on the criteria of Algorithm 560.

In one embodiment of the present invention, the Intervention Manager 460 randomly selects one of the performance interventions from the group of qualifying interventions. In another embodiment of the present invention, input from a manager of the contact center 400 narrows the choices of performance interventions. In yet another embodiment of the present invention, the performance intervention with the highest priority is selected.

In another embodiment of the present invention, Algorithm 560 offers an agent 40 a menu of performance interventions from which the agent 40 can select one or more specific interventions. The menu can include performance interventions having various priorities, for example several high-priority interventions and low-priority interventions. The menu can provide an indication of priority as well as any approaching deadlines for completing time-sensitive interventions.

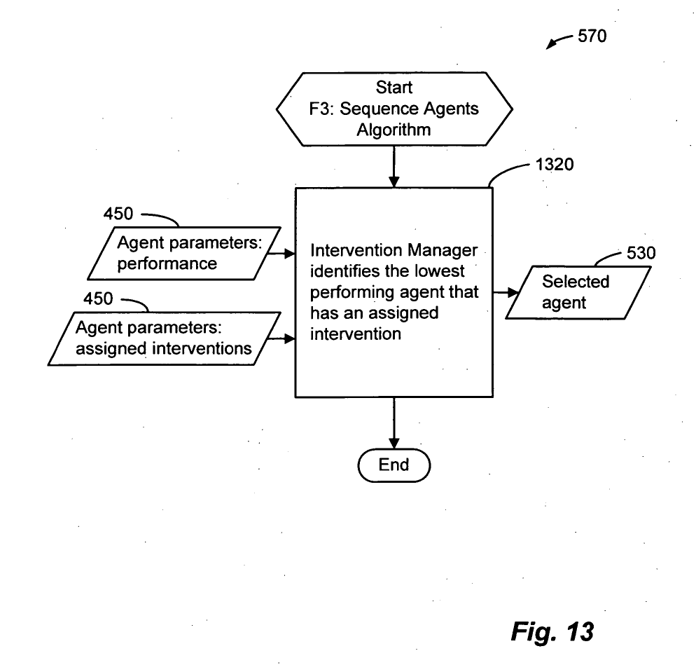

Turning now to FIG. 13, after the Intervention Manager Algorithm 1000 determines the rate 510 of intervention delivery and the selection 520 of performance interventions, Algorithm 570 makes a selection 530 of one or more agents 40 to receive a performance intervention. Algorithm 570, which is titled Sequence Agents Algorithm, is an exemplary embodiment of Function F3 570 as illustrated in FIG. 5B and FIG. 5C. The agent profiles database 449 supplies Algorithm 570 with the performance of the agents 40 in the contact center 400 who are eligible to receive performance interventions. The database 449 also provides the algorithm 570 with the performance interventions that are assigned to each of these agents 40.

At Step 1320, Algorithm 570 uses agent parameters data 450 from the agent profiles database 449 to select the lowest performing agent 40 as the next agent 40 to receive a performance intervention. The Intervention Manager 460 notifies the agent delivery system 430 of the selected agent 530 and the performance intervention 520 selected by the Select Intervention Algorithm 560. In compliance with these parameters 520, 530 and a delivery rate 510, the intervention delivery system 430 delivers the selected performance intervention 520 to the selected agent 530.

In one embodiment of the present invention, the agent profiles database 449 includes a ranking of the relative performance of each agent 40 who is eligible to receive an intervention. That is, the contact center 400 maintains a list of agents 40 ordered by performance, from the best performing agent 40 to the worst performing agent 40. The Intervention Manager 460 uses the ranked order to compose a sequence of agents 40 to receive performance interventions. The sequence starts with the lowest performing agent 40 and sequentially progresses to higher performing agents 40. In one embodiment of Algorithm 570, Step 1320 proceeds from the lowest rank agent 40 who has an assigned performance intervention. In one embodiment of the present invention, managerial personnel in the contact center 400 can specify specific agents 40 to receive performance interventions, for example overriding a computer-generated sequence.

Those skilled in the art appreciate that the present invention supports a wide range of methodologies for identifying a single agent 40 or a sequence of agents 40 to receive a performance intervention. For example, at Step 1320 in Algorithm 570, the Intervention Manager 460 can elect to select an agent 40 who is average performer, but has an assignment with a rapidly approaching deadline.

Turning now to FIG. 14, an exemplary embodiment of the Deliver Intervention Algorithm 1030 is illustrated. Deliver Intervention Algorithm 1030 communicates agent status information to systems in the contact center 400 to facilitate coordinated interactions between these systems and the contact center's agents 40. At the top of the flowchart 1030, the Intervention Manager 460 provides Algorithm 1030 with data specifying the next agent 40 selected to receive a performance intervention.

At inquiry Step 1410, Algorithm 1030 determines if the selected agent 40 is either on break or is scheduled to be on break within a set period of time. In one embodiment of the present invention, the set period of time is one hour. In another embodiment of the present invention, the set period of time is a multiple of the length of the performance intervention.

If the selected agent 40 is not on break, then Algorithm 1030 executes inquiry Step 1420 to determine if the selected agent 40 is logged onto a terminal 44. Algorithm 1030 executes Step 1430 if the selected agent 40 is on break, scheduled to be on break within a short period of time, or is not logged onto a terminal 44. In Step 1430, Algorithm 1030 notifies the Intervention Manager 460 to reschedule the performance intervention based on the selected agent's lack of availability to receive the intervention.

If at inquiry Step 1420 Algorithm 1030 determines that the selected agent 40 is free from breaks and is logged onto an agent terminal 44, then the algorithm 1030 acquires the agent availability status 435 from the ACD 32. Using this availability status 435, inquiry Step 1440 determines if the selected agent 40 is currently servicing a contact.

If the selected agent is not servicing a contact, then at Step 1460 the Intervention Manager 460 notifies the ACD 32 to log the agent 40 off from servicing contacts so the agent 40 is prepared to receive the intervention. If the selected agent 40 is servicing a contact, then at Step 1450 the Intervention Manager 460 waits until the agent 40 completes servicing the current contact and then notifies the ACD 32 to log the agent 40 off from contact-service duties.

At Step 1470, the ACD 32 has suspended the agent's contact servicing activities and the agent 40 is prepared to receive the performance intervention. At this point, the Intervention Manager 460 notifies the intervention delivery system 430 to commence delivering the performance intervention to the selected agent 40. When the notification is successful, Algorithm 1030 ends and the process of controlling intervention delivery 1040 begins.

In one embodiment of the present invention, the log-off process from the ACD 32 is a manual process. That is, rather than automatically or unilaterally logging off the agent 40 from his/her terminal 44, the process requires manual intervention by the agent 40. In this manner, the agent 40 may opt to not log off and accept a performance intervention; rather, the agent 40 may choose to continue servicing contacts or engage in another discretionary activity. Also, the agent's interaction with the ACD 32 can include the agent 40 notifying the ACD 32 of his/her availability to receive a performance intervention. That is, the agent 40 can send notification that he or she is amenable to a performance intervention at a specific time that can be defined by the Intervention Manger 460.

In one embodiment of the present invention an agent 40 can, when prompted to receive a performance intervention, delay delivery for a predetermined length of time, such as ten minutes. After the predetermined length of time has lapsed, the agent 40 can receive another request to accept a performance intervention. The agent 40 can respond by again delaying delivery. The cycle can repeat indefinitely or alternatively can terminate after a specified number of iterations.

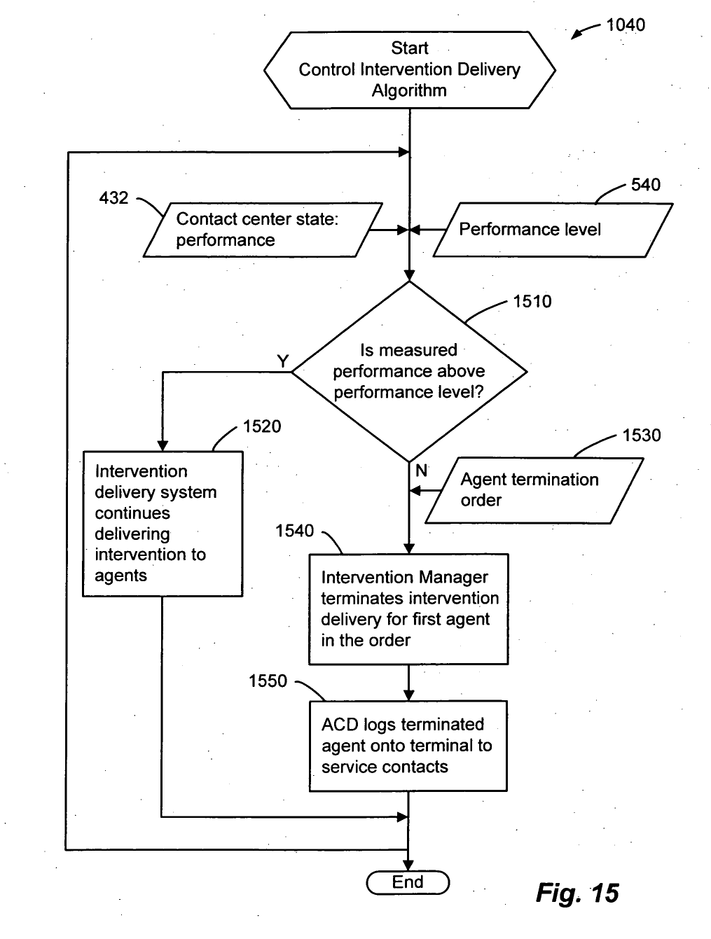

FIG. 15 is a flowchart that illustrates an exemplary embodiment of Algorithm 1040, titled Control Intervention Delivery Algorithm, which initiates after Algorithm 1030. Monitored contact center performance 432 and management input performance level 480 are two inputs to the exemplary embodiment of Algorithm 1040. At inquiry Step 1510, Algorithm 1040 determines if the monitored performance 432 is above the performance level setting 480. If the performance 432 is above the performance level 480, then the contact center's operational performance is acceptable and the Intervention Manager 460 does not interfere with the intervention delivery system's intervention delivery.

If inquiry Step 1510 determines that monitored performance is unacceptable, then Algorithm 1040 accesses an agent termination order 1530. In one embodiment of the present invention, the termination order 1530 is a management input 460. In another embodiment, the termination order 1530 is a random sequence. In yet another embodiment, the termination order 1530 is a derivation of the length of time since each agent 40 has received a performance intervention. For example, the agent 40 who most recently received a performance intervention is the first agent 40 in the termination order 1530, and the agent 40 who has not received a performance intervention for the longest period of time is the last agent 40 in the termination order 1530. The agent termination order 1530 can also be based on a rank of agent performance, a last-in-first-out sequence, a first-in-last-out sequence, or another methodology that serves the operational goals of the contact center 400.

At Step 1540, the Intervention Manager 460 instructs the intervention delivery system 430 to terminate intervention delivery for the first agent 40 on the agent termination order 1530. At Step 1550, the Intervention Manager 460 notifies the ACD 32 to log the terminated agent 40 on a terminal 40 to resume servicing contacts.

After executing either Step 1520 or Step 1550, Algorithm 1040 acquires fresh monitored state data 432 and iterates the process of determining if performance is acceptable and acting on that determination.

Algorithm 1040 supplements the functionality of the previous steps in the Intervention Manager Algorithm 1000 by providing an increased level of responsiveness to dynamic conditions in the contact center 400. That is, in addition to establishing the parameters 510, 520, 530 of intervention delivery, the Intervention Manager 460 intervenes with the delivery process if conditions in the contact center 400 become unacceptable or otherwise unsuitable for delivering performance interventions.

An exemplary embodiment of an Intervention Manager Algorithm 1000 has been described in conjunction with exemplary Functions F1, F2, and F3 550, 560, 570. Those skilled in the art recognize that the present invention supports adapting these functions 550, 560, 570, both in functionality and in sequence of implementation, to achieve a wide range of functional objectives and purposes related to managing intervention delivery in a contact center 400.

In summary, the present invention supports managing the rate of delivering performance interventions to agents in a call center to enhance the capabilities of the agent population while maintaining robust performance of the contact center.

From the foregoing, it will be appreciated that the preferred embodiment of the present invention overcomes the limitations of the prior art. From the description of the preferred embodiment, equivalents of the elements shown therein will suggest themselves to those skilled in the art, and ways of constructing other embodiments of the present invention will suggest themselves to practitioners of the art. Therefore, the scope of the present invention is to be limited only by the claims below.

What is claimed is:

1. A computer-based method for managing delivering performance interventions to agents in a contact center comprising:
delivering performance interventions to at least one of the agents in the contact center at a rate;
determining a state of the contact center; and
responsive to the determining step, adjusting the rate of delivering performance interventions.

2. The computer-based method of claim 1, further comprising setting a state level, wherein the determining step comprises monitoring the state of the contact center, and wherein the adjusting step comprises adjusting the rate of delivering performance interventions on the basis of the monitored state in relation to the state level.

3. The computer-based method of claim 2, wherein the adjusting step further comprises adjusting the rate of delivering performance interventions on the basis of deviation between the monitored state and the state level.

4. The computer-based method of claim 1, wherein determining the state comprises receiving the state from a component of the contact center.

5. The computer-based method of claim 2, further comprising the steps of:
determining if the adjusted rate of delivering performance interventions is sufficient to meet an intervention delivery objective; and
if the adjusted rate of delivering performance interventions is insufficient to meet the intervention delivery objective, adjusting the state level.

6. The computer-based method of claim 5, wherein the intervention delivery objective comprises delivering training in advance of a target completion time.

7. The computer-based method of claim 1, wherein the step of determining the state of the contact center comprises predicting the state of the contact center within a defined interval of time.

8. The computer-based method of claim 7, wherein the defined interval of time is within twenty four hours of a current time.

9. The computer-based method of claim 1, wherein determining the state of the contact center comprises monitoring a performance of the contact center, and wherein the adjusting step comprises reducing the rate of delivering performance interventions if the monitored performance falls below a predetermined level.

10. The computer-based method of claim 9, wherein reducing the rate of delivering performance interventions comprises terminating a performance intervention prior to completing delivery of the performance intervention.

11. The computer-based method of claim 1, wherein the step of determining the state of the contact center comprises monitoring contact volume and handle time.

12. The computer-based method of claim 1, wherein the step of determining the state of the contact center comprises determining a performance of the contact center.

13. The computer-based method of claim 1, wherein the step of determining the state of the contact center comprises determining at least one of a service level, an abandonment rate, a hold time, and a call volume.

14. The computer-based method of claim 1, wherein the adjusting step further comprises increasing the rate of delivering performance interventions if the state is above a predetermined level and decreasing the rate of delivering performance interventions if the state is below the predetermined level.

15. The computer-based method of claim 1, wherein state of the contact center comprises performance of the contact center and wherein delivering performance interventions comprises delivering computer-based training.

16. The computer-based method of claim 1, wherein determining the state of the contact center comprises determining a performance of the contact center, and wherein the adjusting step comprises increasing the rate of delivering performance interventions if the determined performance is above a predetermined level.

17. A method for managing delivering performance interventions to agents in a contact center comprising:
determining a state of the contact center;
setting a state level for the contact center; and
determining a number of performance interventions for delivery to the agents during an increment of time on the basis of the state and the state level.

18. The method of claim 17, further comprising the steps of:
determining an agent performance for each of the agents; and
selecting certain agents from the agents to receive the performance interventions on the basis of the agent performances.

19. The method of claim 18, wherein determining the agent performances comprises ranking each agent, and wherein selecting certain agents further comprises selecting a first agent over a second agent if the first agent's rank indicates lower performance than the second agent's rank.

20. The method of claim 17, wherein determining the number of performance interventions for delivery during an increment of time further comprises:
determining a first number if the state is above the state level; and
determining a second number if the state is below the state level, wherein the first number is larger than the second number.

21. The method of claim 17, further comprising the steps of:
assigning a performance intervention to at least one of the agents in the contact center; and
selecting the at least one agent to receive the performance intervention on the basis of the assignment.

22. The method of claim 17, further comprising the steps of:
determining an agent parameter for at least one of the agents; and
selecting preferred agents from the at least one of the agents to receive the performance interventions on the basis of the agent parameter.

23. The method of claim 22, wherein the agent parameter comprises at least one of a performance intervention assignment and a metric of agent performance.

24. A method for delivering performance interventions to agents in a contact center comprising:
delivering the performance interventions to at least one of the agents in the contact center at a current delivery rate;
identifying a time-sensitive performance intervention for delivery to at least one of the agents in advance of a time;
estimating if the time-sensitive performance intervention will be delivered in advance of the time based on the current delivery rate; and
if the estimating step indicates that the time-sensitive performance intervention will not be delivered in advance of the time, increasing the current delivery rate.

25. The method of claim 24, further comprising the step of receiving a state of the contact center.

26. The method of claim 25, wherein the state of the contact center comprises at least one of a performance of the contact center, a service level, an abandonment rate, a hold time, and a call volume.

27. A computer-based method for supplying performance interventions to agents in a contact center comprising:
providing performance interventions for delivery to at least one of the agents in the contact center at a rate;
receiving a state of the contact center; and
responsive to receiving the state of the contact center, changing the rate of providing performance interventions.

28. The computer-based method of claim 27, wherein the performance interventions are provided to a training system or a workforce management component associated with the contact center.

29. The computer-based method of claim 27, further comprising the step of receiving a state level.

30. The computer-based method of claim 29, further comprising:
comparing the state level and the state of the contact center; and
changing the rate of providing performance interventions based on the comparison.

31. A method for managing agents in a contact center comprising:
receiving a first request for performance interventions to be delivered at a first rate;
responsive to the first request, delivering the performance interventions at a first rate; and
responsive to a change in a state of the contact center, receiving a second request for the performance interventions to be delivered at a second rate.

32. The method of claim 31, further comprising the step of delivering the performance interventions at a second rate in response to the second request.

33. The method of claim 31, wherein the performance interventions are delivered to the agents.

34. The method of claim 31, wherein the first request and the second request are received from a component of the contact center.

35. A computer-readable medium having computer-executable instructions for performing the following steps:
delivering performance interventions to an agent in a contact center at a rate;
determining a state of the contact center; and
responsive to the determining step, adjusting the rate of delivering performance interventions.

36. The computer-readable medium of claim 35, having computer-executable instructions for performing the following additional steps:
setting a state level;
comparing the state level to the state of the contact center; and
adjusting the rate of delivering performance interventions based on the comparison of the state level and the state of the contact center.

37. The computer-readable medium of claim 35, wherein the step of determining the state of the contact center comprises determining one of a service level, an abandonment rate, a hold time, and a call volume.
